(19) United States
(12) Patent Application Publication
(10) Pub. No.: US 2015/0324733 A1
(43) Pub. Date: Nov. 12, 2015

(54) STATE DEPENDENT ELECTRONIC TRANSPORT LABEL

(71) Applicant: Elwha LLC, Bellevue, WA (US)

(72) Inventors: Eleanor V. Goodall, Seattle, WA (US); Roderick A. Hyde, Redmond, WA (US)

(73) Assignee: Elwha LLC, a limited liability company of the State of Delaware

(21) Appl. No.: 14/273,637

(22) Filed: May 9, 2014

(51) Int. Cl. G06Q 10/08

(52) U.S. Cl. CPC G06Q 10/083

(57) ABSTRACT

A transport label for use with a transport container includes one or more controllable, readable indicia for presenting information readable by a reader external to the transport container. Controllable, readable indicia can be updated to present different information based upon a time, location, or physical security parameter of the transport container. The transport label system includes control circuitry and a memory device for storing two or more indicia configurations for the controllable, readable indicia. Controllable, readable indicia, memory device, and control circuitry may be built into a transport container or packaged separately, e.g. for attachment to a transport container. Methods of controlling the transport label system are also described.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

None.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

In an aspect, a method of controlling a transport label system carried by a transport container includes retrieving a first destination address from a memory device under the control of control circuitry, the memory device and the control circuitry forming a portion of the transport label system carried by the transport container; presenting the first destination address on a controllable, readable display element of the transport label system in a format readable by a reader external to the transport container; receiving at least one parameter value indicative of a state of at least one of the transport container and one or more contents of the transport container; determining with the control circuitry whether the state meets at least one rerouting criterion; and if the state meets the at least one rerouting criterion, retrieving a second destination address from the memory device under the control of the control circuitry and presenting the second destination address on the display element of the transport label system. In addition to the foregoing, other method aspects are described in the claims, drawings, and text forming a part of the disclosure set forth herein.

In an aspect, a transport label system includes a memory device configured to be carried by the transport container and adapted to contain at least a first destination address and a second destination address; a controllable, readable display element configured to be carried by the transport container and adapted to present a destination address selected from at least the first destination address and the second destination address in a format readable by a reader external to the transport container; a receiving portion adapted to receive at least one parameter value indicative of a state of at least one of the transport container and one or more contents of the transport container; control circuitry configured to control retrieval of at least one of the first destination address and the second destination address from the memory device and presentation of the at least one of the first destination address and the second destination address by the controllable, readable display element, determine whether the state meets at least one rerouting criterion, and if the state meets the at least one rerouting criterion, control retrieval of the second destination address from the memory device and presentation of the second destination address by the controllable, readable display element. In addition to the foregoing, other system aspects are described in the claims, drawings, and text forming a part of the disclosure set forth herein.

In an aspect, a transport container system includes a transport container; memory device adapted to contain at least a first destination address and a second destination address; a controllable, readable display element carried in or on the transport container adapted to present a destination address selected from at least the first destination address and the second destination address in a format readable by a reader external to the transport container; a receiving portion adapted to receive at least one parameter value indicative of a state of at least one of the transport container and one or more contents of the transport container; and control circuitry configured to control retrieval of at least one of the first destination address and the second destination address from the memory device and presentation of the at least one of the first destination address and the second destination address by the controllable, readable display element, determine whether the state meets at least one rerouting criterion, and if the state meets the at least one rerouting criterion, control retrieval of the second destination address from the memory device and presentation of the second destination address by the controllable, readable display element. In addition to the foregoing, other system aspects are described in the claims, drawings, and text forming a part of the disclosure set forth herein.

In an aspect, a method of controlling one or more controllable, readable indicia on a transport container includes receiving at least one parameter value indicative of at least one of a transport-related time, a transport location, or a physical security of a transport container with a receiving portion located in or on the transport container; determining a change in the at least one parameter value with control circuitry located in or on the transport container; retrieving at least one indicia configuration from a memory device in or on the transport container under the control of the control circuitry in response to the change in the at least one parameter value; and changing information presented by one or more controllable, readable indicia in or on the transport container in accordance with the at least one indicia configuration retrieved from the memory device. In addition to the foregoing, other method aspects are described in the claims, drawings, and text forming a part of the disclosure set forth herein.

In an aspect, a transport label system includes one or more controllable, readable indicia configured to be carried in or on a transport container, the one or more controllable, readable indicia adapted to present information in a format readable by a reader external to the transport container; at least one receiving portion configured to be carried in or on the transport container, the at least one receiving portion adapted to receive at least one parameter value indicative of at least one of a transport-related time, a transport location, or a physical security of the transport container; a memory device configured to be carried in or on the transport container, the memory device configured to store at least a first indicia configuration and a second indicia configuration, wherein at least one of the first indicia configuration and the second indicia configuration includes information to be presented by the one or more controllable, readable indicia; and control circuitry configured to determine a change in the at least one parameter value, select one indicia configuration from the at least a first indicia configuration and the at least a second indicia configuration based upon the change in the at least one parameter value, and configure the one or more controllable, readable indicia according to the selected one indicia configuration. In addition to the foregoing, other system aspects are described in the claims, drawings, and text forming a part of the disclosure set forth herein.

In an aspect, a transport container system includes a transport container; one or more controllable, readable indicia in or on the transport container adapted to present information in a format readable by a reader external to the transport container; at least one receiving portion adapted to receive at least one parameter value indicative of at least one of a transport-related time, a transport location, or a physical security of the transport container; a memory device in or on the transport and configured to store at least a first indicia configuration and a second indicia configuration, wherein at least one of the first indicia configuration and the second indicia configuration includes information to be presented by the one or more controllable, readable indicia; and control circuitry configured to determine a change in the at least one parameter value, select one indicia configuration of the at least a first indicia configuration and the at least a second indicia configuration based upon the change in the at least one parameter value, and configure the one or more controllable, readable indicia according to the selected one indicia configuration. In addition to the foregoing, other system aspects are described in the claims, drawings, and text forming a part of the disclosure set forth herein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1A is an illustration of a transport label system configured as a luggage tag attached to a suitcase.

FIG. 1B is an illustration of the transport label system of FIG. 1A.

FIG. 1C is an illustration of a transport label system including a luggage tag and auxiliary unit.

FIG. 2A is an illustration of a transport label system including a label on a package.

FIG. 2B is an illustration of the label of FIG. 2A.

FIG. 3 depicts rerouting of a package including a transport label system.

FIG. 4 is block diagram of a transport label system

FIG. 5 is block diagram of a transport label system including a transport label and an auxiliary unit.

FIG. 6 is a block diagram of a transport container system.

FIG. 7A is an illustration of a transport container system.

FIG. 7B is an illustration of the transport container system of FIG. 7A in an open configuration.

FIG. 8A is an illustration of an embodiment of a transport container.

FIG. 8B is an illustration of an embodiment of a transport container.

FIG. 9 is a flow diagram of a method of controlling a transport label system carried by a transport container.

FIG. 10 is a flow diagram of a method of controlling a transport label system carried by a transport container.

FIG. 11 is a flow diagram of a method of controlling a transport label system carried by a transport container.

FIG. 12 is a flow diagram of a method of controlling a transport label system carried by a transport container.

FIG. 13 is a flow diagram of a method of controlling a transport label system carried by a transport container.

FIG. 14 is a flow diagram of a method of controlling a transport label system carried by a transport container.

FIG. 15 is a flow diagram of a method of controlling a transport label system carried by a transport container.

FIG. 16 is a flow diagram of a method of controlling a transport label system carried by a transport container.

FIG. 17 is a flow diagram of a method of controlling one or more controllable, readable indicia on a transport container.

FIG. 18 is a flow diagram of a method of controlling one or more controllable, readable indicia on a transport container.

FIG. 19 is a flow diagram of a method of controlling one or more controllable, readable indicia on a transport container.

FIG. 20 is a flow diagram of a method of controlling one or more controllable, readable indicia on a transport container.

FIG. 21 is a flow diagram of a method of controlling one or more controllable, readable indicia on a transport container.

FIG. 22 is a flow diagram of a method of controlling one or more controllable, readable indicia on a transport container.

FIG. 23 is a flow diagram of a method of controlling one or more controllable, readable indicia on a transport container.

FIG. 24 is a flow diagram of a method of controlling one or more controllable, readable indicia on a transport container.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The embodiments described herein relate to labeling of transport containers. In various aspects, a transport container can be any type of container or package that is used for transporting, carrying or shipping of any sort of materials, goods or items from one location to another. Labels on transport containers may provide various types of information, including, but not limited to, information regarding ownership of the container, contents of the container, origination address, intermediate destination (waypoint) address, delivery time, intermediate destination or waypoint time, or shipping instructions, for example. Embodiments described herein include labeling which can be changed in response to changes in the state of the transport container and/or its contents.

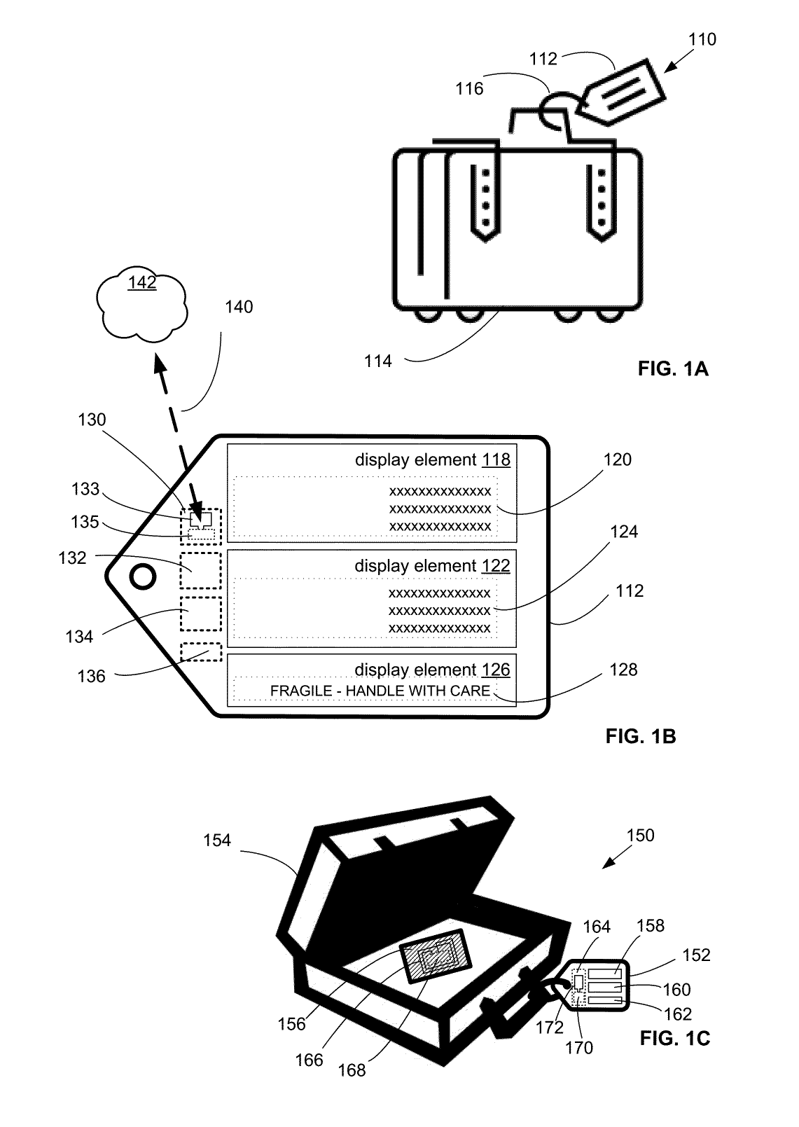

In the example depicted in FIG. 1A and FIG. 1B, transport label system 110 takes the form of a luggage tag 112 which can be attached to suitcase 114 by a strap 116. Luggage tag 112 is shown in greater detail in FIG. 1B. Luggage tag 112 includes a first display element 118, which includes address information 120, which may be, for example, the home address of the owner of the luggage. Luggage tag 112 also includes a second display element 122, which includes address information 124, which may be, for example, a destination address, such as the address of a hotel. Address information 120 and 124 may include, for example, street address, city, state, area code, country, etc., or other information sufficient to identify a location at which the luggage originated or a location to which it is being transported. Luggage tag 112 also includes a third display element 126, which displays a notification 128, for example delivery instructions such as “FRAGILE—HANDLE WITH CARE.” Luggage tag 112 may include additional display elements, for displaying other types of information, including, but not limited to identity and contact information of the owner of the luggage, carrier information (e.g. airline, cruise line, flight number, etc.), starting, intermediate, and final destination airports, and whether the bag has cleared security or customs. Display elements 118, 122, and 126 are electronic displays capable of displaying alphanumeric information. Transceiver 130, electrical control circuitry 132, memory device 134 and battery 136 are contained within luggage tag 112. Transceiver 130 receives a signal 140 from remote location 142. Transceiver 130 includes an antenna 133 and circuitry 135 for receiving a signal 140 sent remotely to the luggage tag 112, or transmitting of a signal 140 remotely from the luggage tag 112. Remote location 142, may be, for example, a remote location authorized by the owner of a piece of luggage or a remote location controlled by a carrier to track a transport container and update information displayed on the transport label. Electrical control circuitry 132 controls the display of information on one or more display elements 118, 122, and 126 in response to a signal from remote location 142 by transceiver 130. Alternative address information may be stored, for example in memory device 134. In the embodiment of FIGS. 1A and 1B, transceiver 130, electrical control circuitry 132, memory device 134 and battery 136 are contained within luggage tag 112.

In some aspects it may be preferable to package some components of the transport label system separately from the display elements. FIG. 1C depicts an embodiment in which transport label system 150 includes a luggage tag 152 attached to a suitcase 154, and auxiliary unit 156 which is placed inside suitcase 154. In the embodiment of FIG. 1C, display elements 158, 160, and 162 (which are substantially similar to display elements 118, 122, and 126) are located on luggage tag 152, but most or all other system components reside in auxiliary unit 156. Signals for controlling display elements 158, 160 and 162 are transmitted to receiving portion 164 including antenna 166 and circuitry 168 in luggage tag 152 from transmitter 170 including antenna 172 and circuitry 174 in auxiliary unit 156. In this way luggage tag 152 may be smaller, lighter, and less expensive to construct, while batteries and electronic components in auxiliary unit 156 are less constrained with regard to size, weight, and durability.

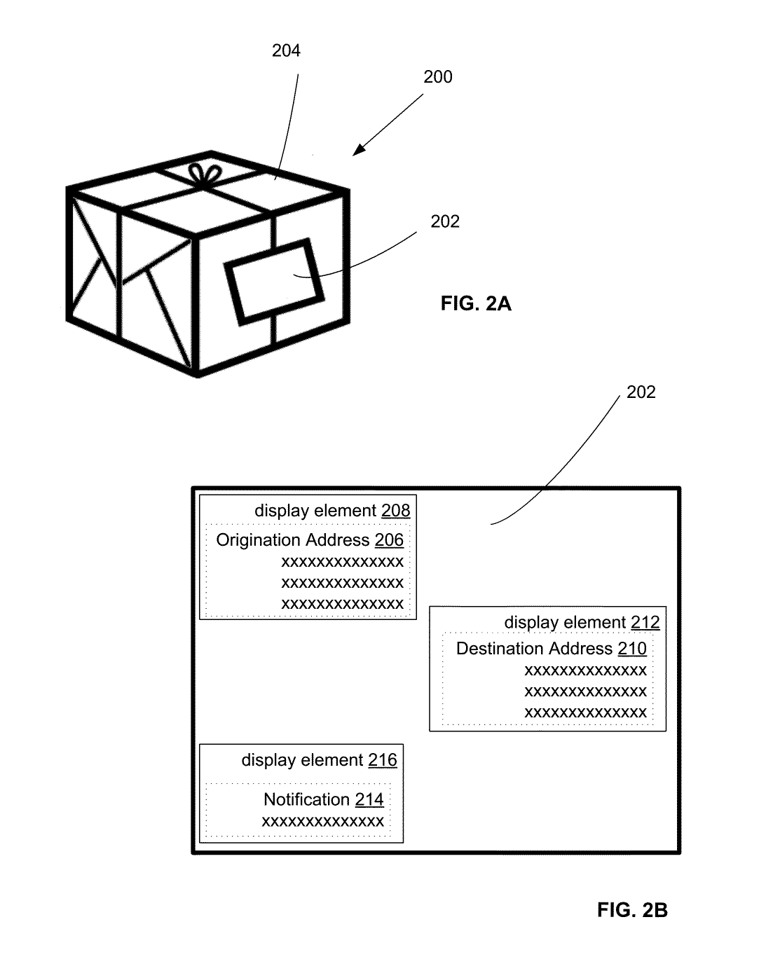

FIGS. 2A and 2B illustrate an example of a transport label system 200 including a label 202 on a package 204. As shown in FIG. 2A, label 202 may be adhered to package 204 with an adhesive, as is used with a conventional label, although label 202 is an active, controllable label, as will be described in greater detail herein below. Label 202 on a package 204, which is being shipped from a vendor to a customer, may list the names and address of a vendor (e.g. as origination address 206 displayed on display element 208) and name and address of a customer (destination address 210 on display element 212) and one or more notification 214 regarding the identity of the shipping service (e.g., FedEx or UPS) or delivery instructions (such as “keep refrigerated,” or “2-day delivery”) on display element 216, as shown in greater detail in FIG. 2B. In an aspect, transport label system 200 includes a memory device, receiving portion and control circuitry (not shown) which are packaged on label 202, as described in connection with FIGS. 1A and 1B. Alternatively, shipping label system 200 includes one or more of memory device, receiving portion and control circuitry packaged separately in an auxiliary unit which can be carried within package 204, as described in connection with FIG. 1C.

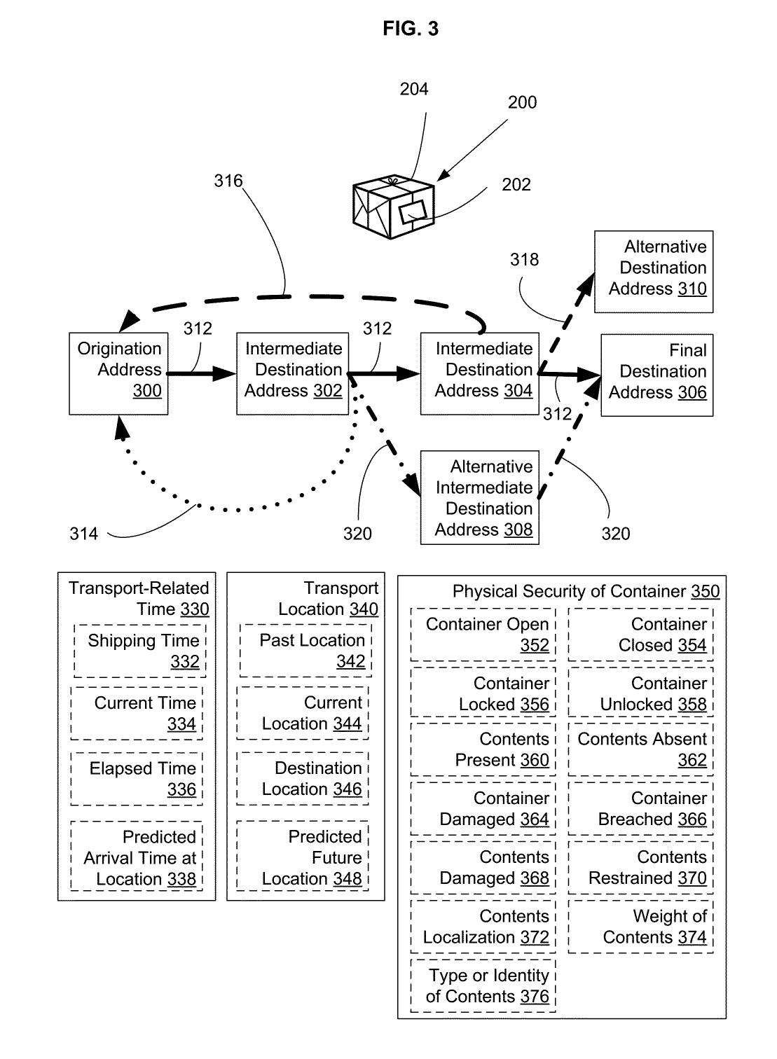

FIG. 3 illustrates circumstances under which information provided by a label 202 on a package 204 may be updated as package 204 is shipped from one location to another, through the use of a shipping label system 200 as described in connection with FIGS. 2A and 2B. Typically, a shipping service will be contracted to transport package 204 from a first location (having origination address 300) to a second location (having final destination address 306). Under normal circumstances, package 204 may be transported from origination address 300 to final destination address 306 via one or more intermediate destinations (e.g., having intermediate destination address 302 and intermediate destination address 304), along an original route 312 (indicated by solid arrows). However, the route may be changed for various reasons. For example, if the customer cancels the order, package 204 may be returned to the vendor at origination address 300 before it has reached final destination address 306. For example, package 204 may return via route 314 (indicated by dotted arrow) from intermediate destination address 302.

As another example, if it is determined that package 204 or its contents are damaged, package 204 may be returned to origination address 300 from intermediate destination address 304 via route 316, represented by a dashed arrow. Alternatively, a damaged package may be sent to an alternative destination address 310, via route 318 for disposal or for repair or repackaging. In another example, if it is determined that package 204 cannot be shipped to final destination address 306 via intermediate destination address 304 (for example, due to delays or closure at an airport), package 204 may be rerouted so that it is shipped via alternative intermediate destination address 308, along route 320 (indicated by dash-dot arrows). The examples shown in FIG. 3 depict only a few circumstances under which a package may be rerouted; it will be appreciated that many other circumstances are possible.

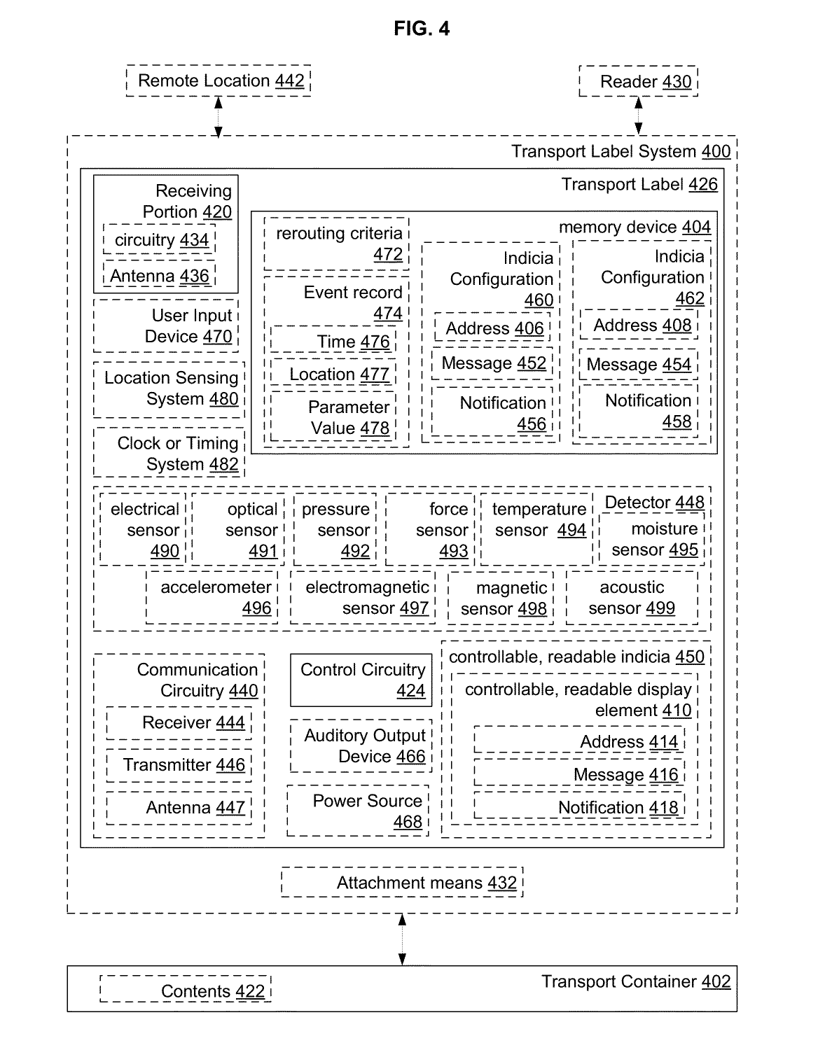

Rerouting of package 204 is based upon the state of the transport container and/or its contents, as determined based on a value of one or more parameters indicative of a transport-related time 330, transport location 340, or physical security of the transport container 350. Rerouting of package 204 can include changing one or more intermediate or final destination addresses, changing a mode of transportation, changing a flight number, changing a delivery or intermediate destination time, etc. A transport related time 330 can be, e.g. a shipping time 332 (time at which the container was shipped), current time 334, elapsed time 336, or predicted arrival time at a location 338. A transport location 340 can be, e.g., a past location 342, current location 344, destination location 346, or predicted future location 348. A parameter indicative of a physical security of a container may be indicative, for example, of the container being open, as indicated at 352; the container being closed, as indicated at 354; the container being locked, as indicated at 356; the container being unlocked, as indicated at 358; the contents of the container being present, as indicated at 360, or absent, as indicated at 362; the container being damaged, as indicated at 364; the container being breached, as indicated at 366; the contents of the container being damaged, as indicated at 368; the contents of the container being restrained, as indicated at 370; the localization of the contents within the container, as indicated at 372; the weight of the contents, as indicated at 374; or the type or identity of the contents, as indicated at 376. Detected or determined parameter values are compared to rerouting criteria to determine whether rerouting is necessary. For example, if the predicted arrival time at a location (e.g. the final destination address 306) will be later than is acceptable (e.g., due to weather-related transportation delays), the transport container may be rerouted to an alternative destination address 310. In this example, the parameter is the predicted arrival time, and the rerouting criterion may be the latest acceptable arrival time. Thus, if the predicted arrival time exceeds the latest acceptable arrival time, the rerouting criteria are met and the transport container is rerouted. In another example, the parameter value indicates that the container is open 352. The rerouting criterion is a stored value corresponding to the container being open. If the parameter value is equal to the stored value, the rerouting criterion is matched, so the transport container is rerouted. For example, an open transport container may be rerouted back to the origination address so that missing contents can be replaced and the container reshipped. Approaches for determining whether rerouting of package 204 is necessary, for changing the information presented by transport label 202, and recording information regarding events resulting in rerouting are described in greater detail in connection with FIG. 4.

FIG. 4 is a schematic block diagram that depicts a transport label system 400 402. Transport label system 400 includes memory device 404, controllable, readable display element 410, receiving portion 420, and control circuitry 424. In an aspect, controllable, readable display element 410 can be configured as a transport label 426 adapted for attachment to the transport container 402, e.g. as depicted in FIGS. 1A-1C and 2A-2B. In an aspect, memory device 404, receiving portion 420 and control circuitry 424 can be packaged with the transport label, as depicted in FIG. 1B. In an aspect, transport label system includes attachment means 432 for attaching the transport label to the transport container, which may be, for example, an adhesive (as in the embodiment of FIGS. 2A-2B), or one or more strap (as in the embodiment of FIGS. 1A and 1B), band, tie, cable, cord, chain, magnet, screw, rivet, tape, any sort of connector or fastener, or other forms of attachment, as are well known to those having ordinary skill in the art.

Memory device 404 is configured to be carried by the transport container 402 and adapted to contain at least a first destination address 406 and a second destination address 408.

Receiving portion 420 is adapted to receive at least one parameter value indicative of a state of at least one of the transport container 402 and one or more contents 422 of the transport container. In an aspect, receiving portion 420 is adapted to receive at least one parameter value from at least one detector 448, which is configured to detect a parameter indicative of the state of the at least one of the transport container 402 and one or more contents 422 of transport container 402. Such a parameter value may be indicative of a physical security of a container and/or its contents. In another aspect, receiving portion 420 is adapted to receive at least one parameter value from other sources, either on board the transport label system, or remote from the transport label system. Parameters may include parameters indicative of a transport-related time, e.g. a current time or elapsed time from either clock or timing system 482 or a clock or timing system at a remote location, a time value stored in memory device 404 (e.g. a stored shipping time), or a time value determined by control circuitry 424 (e.g. a predicted arrival time at a destination). In an aspect, transport label system 400 includes a clock or timing system 482 operatively connected to the receiving portion, wherein receiving portion 420 is adapted to receive the at least one parameter value indicative of the state of the at least one of the transport container 402 and one or more contents 422 of the transport container 402 from the clock or timing system 482.

In an aspect, transport label system 400 includes a location sensing system 480 operatively connected to receiving portion 420, wherein the receiving portion 420 is adapted to receive the at least one parameter value indicative of the state of the at least one of the transport container 402 and one or more contents 422 of the transport container 402 from the location sensing system 480. Location sensing system 480 may be a global positioning system (GPS), local positioning system, or other localization system, for example. In an aspect, receiving portion 420 receives a parameter indicative of a transport location, which may be received from a location system 480, which may be, for example, a GPS system. Location sensing system 480 may communicate with remote devices and systems in order to determine the current location of the transport label system, for example, as described in U.S. Pat. No. 8,482,399 issued Jul. 9, 2013 to Breed, which is incorporated herein by reference. In another aspect, receiving portion 420 may receive a stored location parameter from memory device 404, or a location parameter determined by control circuitry 424 (e.g., a predicted future location of the transport container). In various aspects, receiving portion 420 may include one or more circuitry components such as a receiver, data acquisition or signal processing circuitry, which may include one or more of hardware and software, represented as circuitry 434 in FIG. 4. In various aspects, receiving portion 420 is adapted to receive one or more wireless signals, which may be electromagnetic (e.g. radio frequency) or infrared signals. For example, in an aspect receiving portion 420 include antenna 436. In some aspects, receiving portion 420 is adapted to receive one or more signals via a wired connection (e.g., in embodiments in which receiving portion 420 receives a parameter value from a detector, e.g. detector 448, the parameter value may be received via a wired connections. In some aspects, receiving portion 420 is capable of receiving more than one type of signal. Receiving portion may include analog and/or digital data handling capabilities.

Control circuitry 424 is configured to control retrieval of at least one of the first destination address 406 and the second destination address 408 from the memory device 404 and presentation of the at least one of the first destination address 406 and the second destination address 408 by controllable, readable display element 410, determine whether the state meets at least one rerouting criterion, and if the state meets the at least one rerouting criterion, control retrieval of the second destination 408 address from the memory device and presentation of the second destination address 408 by the controllable, readable display element 410. In an aspect, control circuitry 424 includes electrical circuitry which may include hardware and software components.

In an aspect, transport label system 400 includes communication circuitry 440 operatively connected to control circuitry 424 and adapted for wireless communication with a remote location 442. For example, communication circuitry 440 may provide for wireless communication with remote location 442 via WiFi, cellular network, or other communication network or technology, including but not limited to satellite communication, microwave radio, broadcast radio, microwave radio, free-space optical link, LAN (Local Area Network), MAN (Metropolitan Area Network), WAN (Wide Area Network), infrared WiFi, and Bluetooth. Control circuitry 424 and/or communication circuitry 440 can be preconfigured for communication with remote location 442 such that when the system is turned on by a user it automatically establishes a connection with the remote location, without instruction by the user. Communication circuitry 440 may include one or both of receiver 444 and transmitter 446, and at least one antenna 447. Receiver 444 and transmitter 446 may be separate elements or components of a transceiver. Antenna 447 may be used by receiver 444 and/or transmitter 446, or receiver 444 and transmitter 446 may have separate antennas. In an aspect, communication circuitry 440 is adapted for communication with one or more contents 422 of the transport container 402. For example, communication circuitry 440 may include an RFID detector for checking an RFID associated with one or more contents 422 of transport container 402, for example using an approach as described in U.S. Pat. No. 8,448,860 issued May 28, 2013 to Lyon, which is incorporated herein by reference. Other communication aspects may be as described in U.S. Patent Publication 2003/0163287 published Aug. 28, 2003 to Vock et al., which is incorporated herein by reference. Communication between communication circuitry 440 and contents 442 can take place via wired connection, or via a wireless connection, e.g. radiofrequency or other electromagnetic signal, infrared or other optical signal, using communication technologies such as BlueTooth, ZigBee, local area network (LAN), wireless local area network (WLAN), Body Area Network (BAN), cellular network, or WiFi.

In an aspect, transport label system 400 includes at least one detector 448 configured to detect a parameter indicative of the state of the at least one of the transport container 402 and one or more contents 422 of transport container 402, the at least one detector 448 operatively connected to receiving portion 420 and adapted to provide the at least one parameter value indicative of the state of the at least one of the transport container and one or more contents of the transport container to the receiving portion. In an aspect, detector 448 includes one or more sensors. Detector 448 may also include circuitry comprising hardware and/or software for configure the detector to detect one or more parameter of interest. In an aspect, the at least one detector 448 is configured to detect whether transport container 402 is closed. In an aspect, the at least one detector 448 is configured to detect whether transport container 402 is locked. In an aspect, the at least one detector 448 is configured to detect whether transport container 402 is open. In another aspect, the at least one detector 448 is configured to detect whether transport container 402 has been breached (e.g. by accidental or intentional damage resulting in a hole or other opening in the container)In an aspect, the at least one detector 448 is configured to detect the presence or absence of one or more contents in transport container 402. In an aspect, the at least one detector 448 is configured to detect the type or identity of one or more contents in transport container 402. In an aspect, the at least one detector 448 is configured to detect the weight of the contents of transport container 402. In various aspects, the at least one detector 448 includes at least one electrical sensor 490, optical sensor 491, pressure sensor 492, force sensor 493, temperature sensor 494, moisture sensor 495, accelerometer 496, an electromagnetic sensor 497, a magnetic sensor 498, or acoustic sensor 499, for example.

Whether the container is open or closed, or locked or unlocked, can be determined with the use of electrical contact sensors, for example as described in U.S. Pat. No. 8,516,864 issued Aug. 27, 2013 to Greiner et al., U.S. Pat. No. 5,541,562 issued Jul. 30, 1996 to Fletcher et al., and U.S. Pat. No. 8,354,927 issued Jan. 15, 2013 to Breed, each of which is incorporated herein by reference. Whether the container is open or has been breached can be determined by detection of light or other electromagnetic radiation (e.g., RF) inside the container by use of photodetectors, RF detectors, or other electromagnetic detectors. Such light or electromagnetic radiation can be from the ambient environment, from an artificial source carried into the container, etc. Presence or absence of container contents can be determined by detecting the weight of the container with a force transducer or strain gauge in, on, or within the container, a handle used to carry the container, or a label attached to the container, or by detecting pressure applied to the container by the contents of the container. Weight sensing is described, for example, in U.S. Pat. No. 7,592,916 issued Sep. 22, 2009 to Staples and U.S. Pat. No. 7,439,456 issued Oct. 21, 2008 to Ogunnaike, each of which is incorporated herein by reference. Damage to the container may be determined by an sensing an acoustic profile of the container, e.g. as described in connection with U.S. Pat. No. 6,236,313 issued May 22, 2001 to Eskildsen et al., which is incorporated herein by reference, or sensing parameters indicative of damage to the container, such as temperature or moisture levels outside the conditions considered to be safe for the container (see, for example U.S. Pat. No. 8,354,927 issued Jan. 15, 2013 to Breed, which is incorporated herein by reference). Similarly, damage to container contents may be indicated unacceptable temperature or moisture levels within container, or by an unusual electrical, acoustic or chemical profile of the container contents. See, e.g. U.S. Pat. No. 8,499,613 issued Aug. 6, 2013 to Ziglioli et al. and U.S. Pat. No. 8,482,399 issued Jul. 9, 2013 to Breed, each of which is incorporated herein by reference. Restraint of container contents may be determined through the use of force, strain, or pressure transducers, in a manner similar to that used to determine restraint of vehicle passengers by a seatbelt, for example as described in U.S. Pat. No. 6,362,734 issued Mar. 26, 2002 to McQuade et al., which is incorporated herein by reference, or by sensing acoustic signals indicative of movement of container contents within the container, for example as described in U.S. Pat. No. 8,159,338 issued Apr. 17, 2012 to Breed, which is incorporated herein by reference. Localization of the contents within a container can be determined, for example, by sensing force or pressure of a container contents on a particular portion of the container interior, or by sensing presence or contents at a particular location within the container with various types of sensors, including but not limited to, optical, electrical acoustic, chemical, or other sensors, for example as described in U.S. Pat. No. 5,653,462 issued Aug. 5, 1997 to Breed et al., which is incorporated herein by reference. Type or identity of the contents, and presence of specific contents, can be detected by sensing the presence (or absence) of an RFID associated with one or more contents and/or determining whether the type/identity of the contents indicated by the RFID matches an expected type/identity of the contents, see, e.g. U.S. Pat. No. 8,448,860 issued May 28, 2013 to Lyon, which is incorporated herein by reference. U.S. Pat. No. 8,428,904 issued Apr. 23, 2013 to Vock et al., which is incorporated herein by reference, describes sensing of motion-related events and environmental conditions. Alternatively, or in addition, contents may include a magnetic tag, which can be detected with a magnetic sensor.

Controllable, readable display element 410 is configured to be carried by the transport container 402 and adapted to present a destination address 414 selected from at least the first destination address 406 and the second destination address 408 in a format readable by a reader 430 external to the transport container 402. In an aspect, the controllable, readable display element 410 is adapted to present the destination address selected from at least the first destination address and the second destination address in a format readable by a human. Display elements having human readable formats include visually detectable displays (e.g., including electronic ink, light emitting diode (LED), organic light emitting diode (OLED), liquid crystal display (LCD), 7-segment or electrophoretic displays) and tactile displays, for example. Machine-readable indicia include various types of optically, electrically or magnetically detectable code or text. In an aspect, the controllable, readable display element 410 is adapted to present the destination address (address 414) selected from at least the first destination address and the second destination address in a format readable by a machine. In various aspects, the controllable, readable display element 410 includes at least one of electronic ink, an RFID, a tactile display, a visual display, optically detectable indicia, electromagnetically detectable indicia, and magnetically detectable indicia. In general, controllable, readable display element 410 may be considered a form of controllable, readable indicia 450, and address 414 and other readable information presented thereon are examples of various possible indicia configurations. Controllable, readable indicia include electrically controllable machine readable indicia, for example, an electrically controlled display, displaying, e.g., a bar code (including linear or two-dimensional bar codes, e.g. a QR code), a magnetic strip, an active RFID or data tag (e.g. a Bokode), an infrared (IR) or radio frequency (RF) transmitter, or a near field communication (NFC) device or chip. Controllable, readable indicia may include one or more light emitting diode (LED), organic light emitting diode (OLED), liquid crystal display (LCD), 7-segment or electrophoretic display, for example. In its simplest form, a controllable, readable indicia may include passive machine readable indicia (e.g. a printed label) having an electrically controllable cover that permits or obstructs viewing/detection of the passive machine readable indicia. Controllable, readable indicia may also include for example, one or more lights (e.g. light emitting diodes), segmented or pixelated electronic visual display (e.g., liquid crystal, electrophoretic, electroluminescent, electrochromic, photoluminescent, or electromechnical), a refreshable Braille display, or a haptic interface (based on vibratory motors, electroactive polymers, piezoelectric, electrostatic and subsonic audio wave surface actuation, audio haptics, electrostatic haptics, or electric fields, for example). While many embodiments depicted herein include controllable, readable indicia that are visually detectable, on the outside of the transport container, it will be appreciated that controllable, readable indicia may be contained within or built into the transport container and not visually detectable from outside the container, but may be read with a suitable reading device from outside the container. If information is provided by controllable, readable display element 410 or other controllable, readable indicia 450 in a human readable format, reader 430 may be a human. If information is provided by controllable, readable display element 410 or other controllable, readable indicia 450 in a machine readable format, reader 430 may be any of various types of readers suitable for use with the machine readable information presented by display element 410/controllable, readable indicia 450. For example, reader 430 may be a bar code reader, a magnetic strip reader, an RFID reader, an IR or RF receiver, a near field communication device, a camera or other optical detector, any of which may include appropriate signal processing and/or pattern recognition hardware and/or software appropriate for extracting information from the detected signal.

As discussed in connection with FIGS. 1A-1C and 2A-2B, controllable, readable display element 410 may display one or more addresses as well as other information. Transport label system 400 and other systems described herein may include one or multiple controllable readable display elements and/or controllable, readable indicia, and each display element or readable indicia may display or present one or more type of information, including, e.g., address 414, message 416, or notification 418, for example. In an aspect, one or more addresses 406, 408, messages 452, 454, or notifications, 456, 458 (which in general may be considered examples of one or more indicia configurations 460, 462) are stored in memory device 404, from which they may be retrieved for presentation on controllable readable display element 410/controllable, readable indicia 450. Indicia configurations may include, but are not limited to, text, numerals, symbols, or images, depending upon the capabilities of the controllable readable display element 410/controllable, readable indicia 450 and the information to be communicated.

In an aspect, transport label system 400 includes an auditory output device 466. For example, in an aspect auditory output device 466 is adapted to produce an auditory output indicative of the destination address selected from at least the first destination address and the second destination address. Auditory output device 466 may also be used to generate various other warnings, alarms, or notifications, under the control of control circuitry 424. Auditory output device 466 may include a speaker driven by a sound card to generate an alarm/notification sound or play a pre-recorded or synthesized voice message, or an electrically controlled beeper, buzzer, or bell.

In an aspect, transport label system 400 includes a power source 468 operatively connected to at least one of the memory device 404, the controllable, readable display element 410, the receiving portion 420, and the control circuitry 424. Power source 468 may include, for example, a battery, an energy scavenging device, or an energy receiving device.

In an aspect, the control circuitry 424 is configured to control presentation of the at least one of the first destination address 406 and the second destination address 408 by the controllable, readable display element 410 so that the at least one of the first destination address 406 and the second destination address 408 is displayed continuously. In an aspect, the control circuitry 424 is configured to control presentation of the at least one of the first destination address 406 and the second destination address 408 by the controllable, readable display element 410 so that the at least one of the first destination address 406 and the second destination address 408 is displayed periodically. In an aspect, the control circuitry 424 is configured to control presentation of the at least one of the first destination address 406 and the second destination address 408 by the controllable, readable display element 410 so that the at least one of the first destination address 406 and the second destination address 408 is displayed in response to a query.

In an aspect, transport label system 400 includes a receiver 444 operatively connected to the control circuitry 424. Receiver 444 may form a part of communication circuitry 440, as depicted in FIG. 4, which may also include one or more transmitter 466. In an aspect, receiver 444 includes an RF receiver that is adapted for receiving a query.

In an aspect, transport label system 400 includes user input device 470 operatively connected to the control circuitry 424, wherein user input device 470 is adapted for receiving a query from a user. In various aspects, user input device 470 includes a keyboard, keypad, or other touch sensitive or touch operated device, a voice interface, or a digital data reader (e.g., a bar code reader, magnetic strip reader, data tag reader, RFID reader, or near field communication device). In an aspect, user input device 470 is adapted to receive an alphanumeric sequence representing a password, which may include, but is not limited to, an identity or access code. User input device 470 may be adapted to receive an identity or access code, a password, or a biometric input indicative of user identification from the user (for example, a voice signal for voice pattern recognition, image or other data signal for fingerprint recognition, retinal vascularization recognition, facial recognition, or other types of biometric identification signals).

As noted above, control circuitry 424 is configured to determine whether the state of at least one of the transport container 402 and one or more contents 422 of the transport container, as indicated by the at least one parameter value received by receiving portion 420, meets at least one rerouting criterion, and if the state meets the at least one rerouting criterion, to control presentation of the second destination address 408 by the controllable, readable display element 410. Various rerouting criterion may be established by appropriate configuration of the control circuitry, which may be accomplished in hardware, software, or firmware. In an aspect, control circuitry 424 is configured to determine whether the state meets the at least one rerouting criterion by determining whether the at least one parameter value falls within a range of values. This is accomplished, for example, by comparing the parameter value with upper and lower limits of the range of values, which can be performed by electronic circuitry using hardware or software methods known to those skilled in the art. In another aspect, determining whether the state meets the at least one rerouting criterion includes determining whether the at least one parameter value exceeds a maximum value, determining whether the at least one parameter value is less than a minimum value, or determining whether the at least one parameter value is indicative of a state that matches one or more pre-defined states. One or more rerouting criteria 472 may be stored in memory device 404 in transport label system 400, from which they may be accessed by control circuitry 424 in order to determine whether the state meets a rerouting criterion.

In an aspect, FIG. 4 depicts a transport label system (400, 402), which includes one or more controllable, readable indicia 450 configured to be carried in or on a transport container 402, at least one receiving portion 420, memory device 404, and control circuitry 424. Controllable, readable indicia 450 are adapted to present information in a format readable by a reader 430 external to the transport container. Receiving portion 420 is configured to be carried in or on the transport container, and is adapted to receive at least one parameter value indicative of at least one of a transport-related time, a transport location, or a physical security of the transport container. Memory device 404 configured to be carried in or on the transport container and to store at least a first indicia configuration 460 and a second indicia configuration 462, wherein at least one of the first indicia configuration 460 and the second indicia configuration 462 includes information to be presented by the one or more controllable, readable indicia 450. In an aspect, control circuitry 424 is configured to determine a change in the at least one parameter value, select one indicia configuration from the at least a first indicia configuration 460 and the at least a second indicia configuration 462 based upon the change in the at least one parameter value, and configure the one or more controllable, readable indicia 450 according to the selected one indicia configuration. In an aspect, control circuitry 424 may edit the selected one indicia configuration so as to configure the one or more controllable, readable indicia 450; this editing may comprise modifying at least one of the format, color, font, dimensions, background, language, or other aspect of the indicia configuration. In an aspect, the editing may comprise processing, encoding, decryption or deletion of at least some information of the indicia configuration.

In an aspect, control circuitry 424 is configured to select the one indicia configuration to be presented by the one or more controllable, readable indicia 450 based upon the change in the at least one parameter value by determining whether the at least one parameter value falls within a range of values. In an aspect, control circuitry 424 is configured to select the one indicia configuration based upon the change in the at least one parameter value by determining whether the at least one parameter value exceeds a maximum value. In an aspect, control circuitry 424 is configured to select the one indicia configuration based upon the change in the at least one parameter value by determining whether the at least one parameter value is less than a minimum value. In an aspect, control circuitry 424 is configured to select the one indicia configuration based upon the change in the at least one parameter value by determining whether the at least one parameter value indicative of a state that matches one or more pre-defined states.

In some aspects, memory device 404 contains at least one event record 474, containing data regarding an event in which one or more rerouting criterion was met. For example, event record 474 may contain the time at which the rerouting criterion was met (time 474), the location at which the rerouting criterion was met (location 476), and the parameter value that cause the rerouting criterion to be met (parameter value 478). In an aspect, memory device 404 may store multiple event records (not shown in FIG. 4). The event record may be used, for example, to assign responsibility for damage to a package to the carrier who was handling the package at the time the damage occurred.

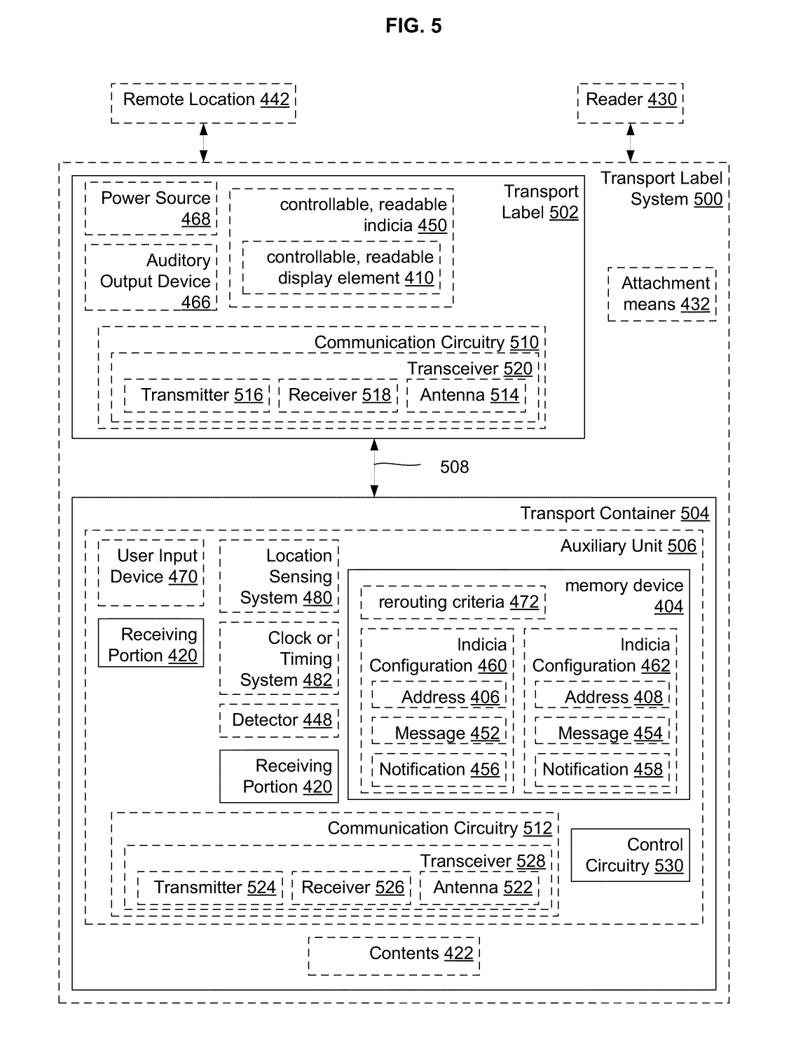

FIG. 5 depicts a transport label system 500 that includes a transport label 502 attached to transport container 504, used in combination with an auxiliary unit 506 that is placed in or on transport container 504, e.g. as depicted in FIG. 1C. Transport label 502 and the at least one auxiliary unit 506 are configured to be operatively connected via communication link 508. In an aspect, transport label 502 includes communication circuitry 510 and auxiliary unit 506 includes communication circuitry 512, which operated together to form a wireless communication link. Communication between communication circuitry 510 and communication circuitry 512 can take place via a wireless connection, e.g. radiofrequency or other electromagnetic signal, infrared or other optical signal, using communication technologies such as BlueTooth, ZigBee, local area network (LAN), wireless local area network (WLAN), Body Area Network (BAN), cellular network, or WiFi. In some aspects, communication circuitry 510 includes one or more antenna 514 used with transmitter 516 and/or receiver 518, one or more of which may be components of transceiver 520. In some aspects, transport label 502 and auxiliary unit 506 are connected by a wire. Similarly, in some aspects, communication circuitry 512 includes one or more antenna 522 for use with transmitter 524 and/or receiver 526, which may be components of transceiver 528. Aside from the communication circuitry 510 and 512 used to provide communication between transport label 502 and auxiliary unit 506, other system components are substantially the same as shown in and described in connection with FIG. 4, and like components have like numbering in FIGS. 4 and 5. In various aspects, at least one of memory device 404, receiving portion 420, and control circuitry 424 is packaged separately from transport label 502 in auxiliary unit 506. FIG. 5 depicts memory device 404, receiving portion 420, and control circuitry 530 packaged in auxiliary unit 506, but system components may be distributed differently between transport label 502 and auxiliary unit 506 (or more than one auxiliary unit), without limitation.

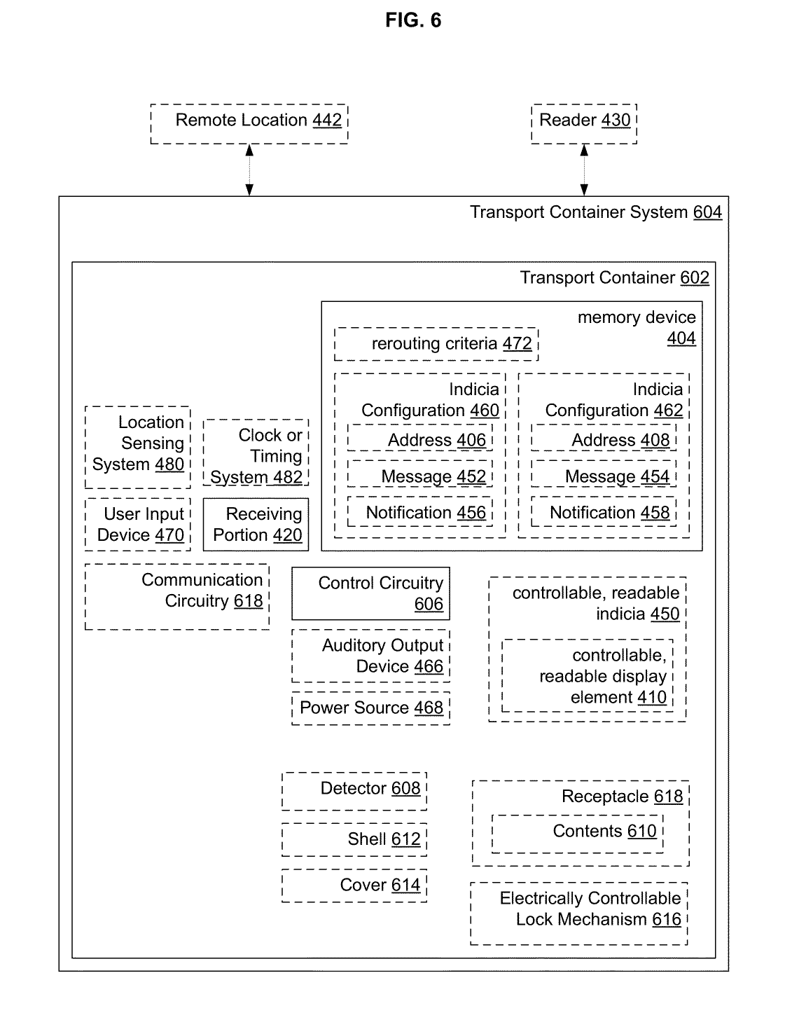

In some aspects, as depicted in FIG. 6, components of a transport label system (including memory device 404, controllable, readable display element 410/controllable readable indicia 450), receiving portion 420 and the control circuitry 606) are built into transport container 602, to form transport container system 604. Transport container system 604 includes transport container 602, memory device 404 adapted to contain at least a first destination address 406 and a second destination address 408, controllable, readable display element 410 carried in or on transport container 602, receiving portion 420, and control circuitry 606. Many components of transport container system 604 are substantially the same as components of the system depicted in FIG. 4. Components that have already been described are not discussed further herein; like numbered components are as described in connection with FIG. 4.

Controllable, readable display element 410 is adapted to present a destination address selected from at least the first destination address 406 and the second destination address 408 in a format readable by a reader 430 external to transport container 602. Receiving portion 420 is adapted to receive at least one parameter value indicative of a state of at least one of the transport container and one or more contents of the transport container.

Control circuitry 606 is configured to control retrieval of at least one of the first destination address 406 and the second destination address 408 from memory device 404 and presentation of the at least one of the first destination address 406 and the second destination address 408 by controllable, readable display element 410, determine whether the state meets at least one rerouting criterion, and if the state meets the at least one rerouting criterion, control retrieval of the second destination address from the memory device and presentation of the second destination address by the controllable, readable display element 410. In an aspect, transport container system 604 includes transport container 602; one or more controllable, readable indicia 450 in or on transport container 602, where controllable, readable indicia 450 are adapted to present information in a format readable by a reader external to transport container 602; at least one receiving portion 420 adapted to receive at least one parameter value indicative of at least one of a transport-related time, a transport location, or a physical security of the transport container 602; memory device 404 in or on the transport container 602 and configured to store at least a first indicia configuration 460 and a second indicia configuration 462, wherein at least one of the first indicia configuration 460 and the second indicia configuration 462 includes information to be presented by the one or more controllable, readable indicia 450; and control circuitry 606. Control circuitry 606 is configured to determine a change in the at least one parameter value received by receiving portion 420, select one indicia configuration of the at least a first indicia configuration 460 and the at least a second indicia configuration 462 based upon the change in the at least one parameter value, and configure the one or more controllable, readable indicia 450 according to the selected one indicia configuration.

In an aspect, transport container system 604 includes a location sensing system 480 in communication with the control circuitry 606, wherein control circuitry 606 is configured to control the one or more controllable, readable indicia 450 based at least in part upon receipt of a signal from location sensing system 480.

In an aspect, transport container system 604 includes at least one detector 608 configured to detect the at least one parameter value indicative of the physical security of the transport container 602, the at least one detector 608 operatively connected to receiving portion 420 and adapted to provide the at least one parameter value to the receiving portion 420. Detector 608 may detect a parameter value indicative of whether the transport container 602 is closed, whether transport container 602 is locked, the presence or absence of one or more contents 610 of the transport container 602, the type or identity of one or more contents 610 of transport container 602, or the weight of one or more contents 610 of transport container 602. In various aspects, detector 608 includes one or more of an electrical sensor, an optical sensor, a pressure sensor, a force sensor, a temperature sensor, a moisture sensor, an accelerometer, an electromagnetic sensor, a magnetic sensor, or an acoustic sensor, for example. Detector 608 may be substantially similar to detector 448, described herein above in connection with FIG. 4. In an aspect, detector 608 is configured to detect a parameter indicative of the state of the at least one of the transport container 602 and one or more contents 610 of transport container 602. In an aspect, detector 608 is operatively connected to receiving portion 420 and adapted to provide the at least one parameter value indicative of the state of the at least one of the transport container and one or more contents of the transport container to receiving portion 420.

In an aspect, transport container 602 includes a shell 612 adapted to receive one or more contents 610 to be contained in the transport container, and at least one cover 614 adapted to allow access to the one or more contents when in an open configuration and to enclose and contain the one or more contents 610 when in a closed configuration; wherein at least one of the memory device 404, receiving portion 420, and control circuitry 606 are located within shell 612. Shell 612 may be a box-like structure in which cover 614 is a lid, or may take other forms. Cover 614 can be movably attached to shell 612, and may pivot, slide, or be lifted away, for example. In an aspect, transport container system 604 includes electrically controllable lock mechanism 616 is configured to lock cover 614 in a closed configuration. Transport container system 604 may also include a receptacle 618 within shell 612, sized and shaped to receive and conform to at least one of the one or more contents 610. In an aspect, control circuitry 606 is configured to control electrically controllable lock mechanism 616.

In an aspect, power source 468 of transport container system 604 may be used to supply power to contents 610. In an aspect, transport container 602 is provided with a power connection for plugging the transport container 602 into a wall outlet or other power source to supply power to some or all components within the case.

In an aspect, transport container system 604 includes a location sensing system 480 in communication with control circuitry 606, wherein control circuitry 606 is configured to control electrically controllable lock mechanism 616 responsive to receipt of a signal from the location sensing system 480 indicative of the transport container system being in an authorized location.

In an aspect, transport container system 604 includes a user input device 470 mounted on an exterior portion of the shell, wherein control circuitry 606 is configured to control at least one electrically controllable lock mechanism 616 responsive to receipt of an authorization signal from a user via user input device 470. As described herein above, in various aspects, user input device 470 may include a keyboard, keypad, or other touch sensitive or touch operated device, a voice interface, or a digital data reader, (e.g., a bar code reader, magnetic strip reader, data tag reader, RFID reader, or near field communication device). In various aspects, user input device 470 is adapted to receive an identity or access code, a password from the user, or a biometric input indicative of user identification (e.g., a voice signal or an image) from the user.

In an aspect, transport container system 604 includes a location sensing system 480 in communication with control circuitry 606, wherein control circuitry 606 is configured to control the one or more controllable, readable display element 410 based at least in part upon receipt of a signal from location sensing system 480. In an aspect, control circuitry 606 is configured for wired communication with one or more contents 610 of transport container 602.

In an aspect, transport container system 604 includes communication circuitry 618 operatively connected to control circuitry 606 and adapted for wireless communication with at least one of the one or more contents 610 of transport container 602. In an aspect, communication circuitry 618 is operatively connected to control circuitry 606 and adapted for wired communication with one or more contents 610 of transport container 602. In an aspect, communication circuitry 618 is operatively connected to control circuitry 606 and adapted for wireless communication with a remote location 442.

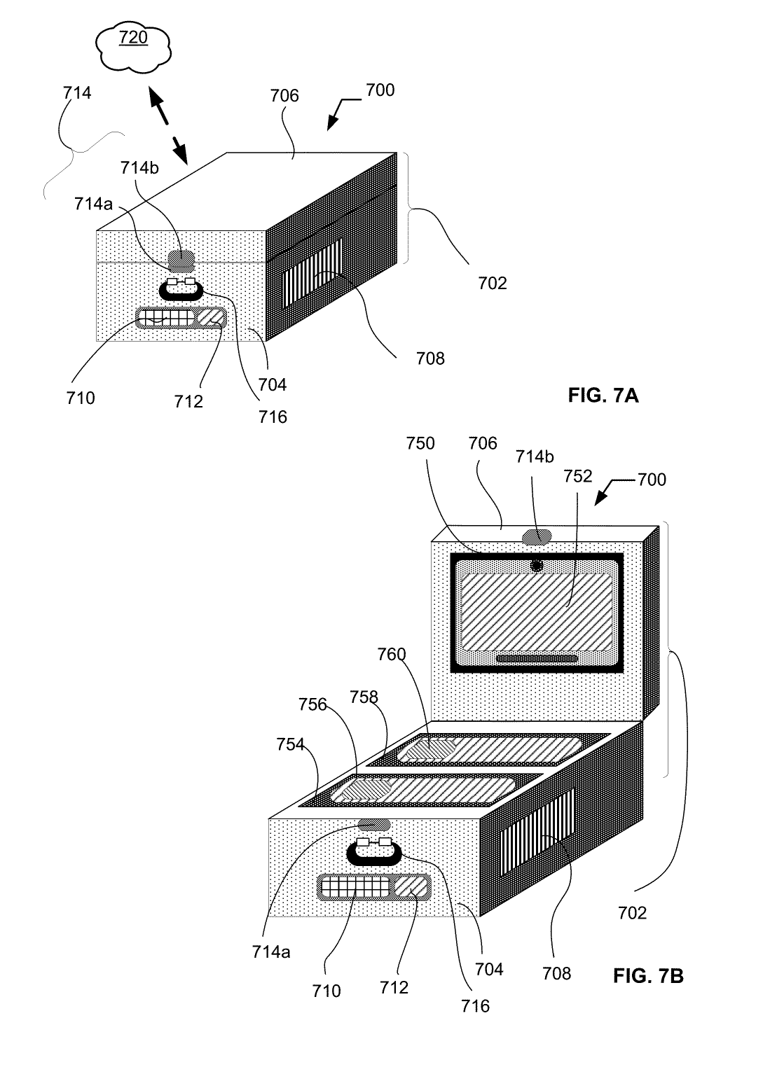

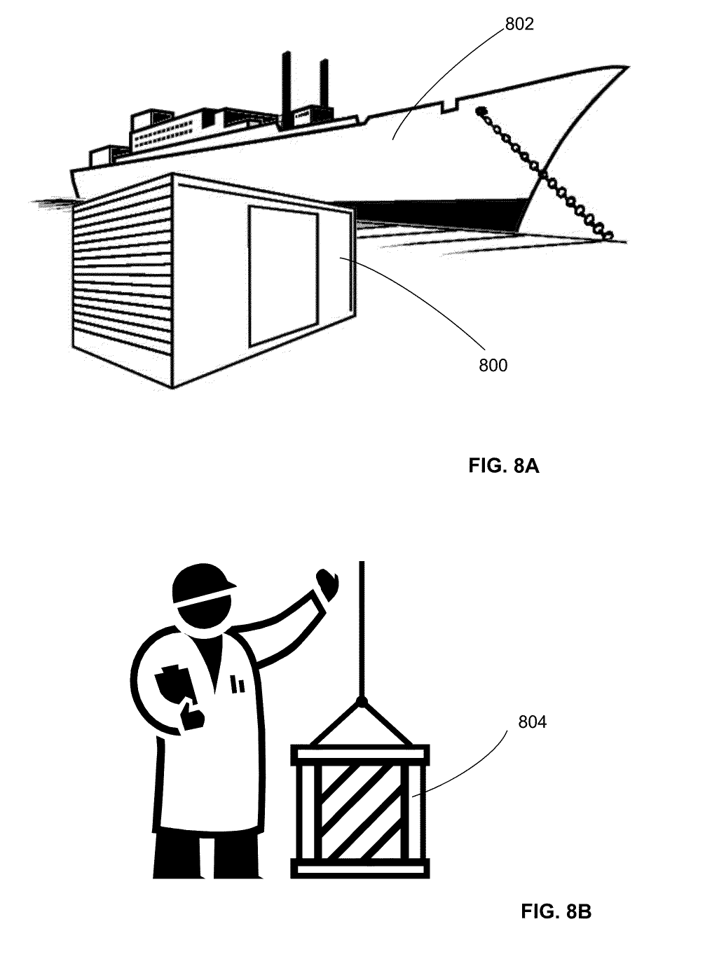

In various aspects, transport container 602 may be a shipping container/cargo container (for example, shipping/cargo container 800 of the typed transported by container ship 802), as depicted in FIG. 8A, a box (e.g. box 204 depicted in FIG. 2A), a crate (e.g., crate 804, depicted in FIG. 8B), a suitcase, an instrument case (e.g., instrument case 702 depicted in FIGS. 7A and 7B), or another type of container or case.

FIGS. 7A and 7B depict an example of a transport container system 700, which is an embodiment of a system as described generally in connection with FIG. 6. Transport container system 700 is configured as an instrument case 702, which includes shell 704 and cover 706 and carrying handle 716. Controllable, readable indicia 708 are located on the exterior of shell 702. Also included are user input device 710 and auditory output device 712, which are controlled by control circuitry (not shown) built into shell 704. In an aspect, a memory device, receiving portion, and control circuitry, as described in connection with FIG. 6, are also built into shell 704. Communication circuitry may be provided within shell 704 for communicating with remote location 720.

Transport container system 700 includes several receptacles within shell 704, sized and shaped to receive and conform to at least one of the one or more contents: shell 704 includes receptacle 750, which is adapted to receive instrument 752, receptacle 754, which is adapted to receive instrument 756, and receptacle 758, which is adapted to receive instrument 760. Cover 706 is adapted to allow access to the one or more contents of instrument case 702 (i.e., instruments 752, 756, and 760) when in an open configuration and to enclose and contain the contents when in a closed configuration. In an aspect, transport container system 700 includes an electrically controllable lock mechanism 714 including components 714a and 714b, configured to lock the cover 706 in the closed configuration. In an aspect, a user input device 710 is mounted on an exterior portion of the shell 702, and the control circuitry is configured to control electrically controllable lock mechanism 714 responsive to receipt of an authorization signal from a user via the user input device 710. In an aspect, the control circuitry is configured to control electrically controllable lock mechanism 714 responsive to receipt of an authorization signal from remote location 720. Alternatively, or in addition, transport container 702 may include a key lock or a combination lock.

In a general sense, it will be recognized that the various embodiments described herein can be implemented, individually and/or collectively, by various types of electrical circuitry having a wide range of electrical components such as hardware, software, firmware, and/or virtually any combination thereof. Electrical circuitry (including control circuitry 424 depicted in FIG. 4, control circuitry 514 in FIG. 5, and control circuitry 606 in FIG. 6, for example) includes electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (which may include, for example, random access, flash, read only, volatile or non-volatile memory devices, etc.), electrical circuitry forming a communications device (e.g., a modem, communications switch, optical-electrical equipment, etc.), and/or any non-electrical analog thereto, such as optical or other analogs (e.g., graphene based circuitry). In a general sense, it will be recognized that the various aspects described herein which can be implemented, individually and/or collectively, by a wide range of hardware, software, firmware, and/or any combination thereof can be viewed as being composed of various types of “electrical circuitry.”

At least a portion of the devices and/or processes described herein can be integrated into a data processing system. A data processing system generally includes one or more of a system unit housing, a video display, memory device such as volatile or non-volatile memory device, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity, control motors for moving and/or adjusting components and/or quantities). A data processing system may be implemented utilizing suitable commercially available components, such as those typically found in data computing/communication and/or network computing/communication systems.

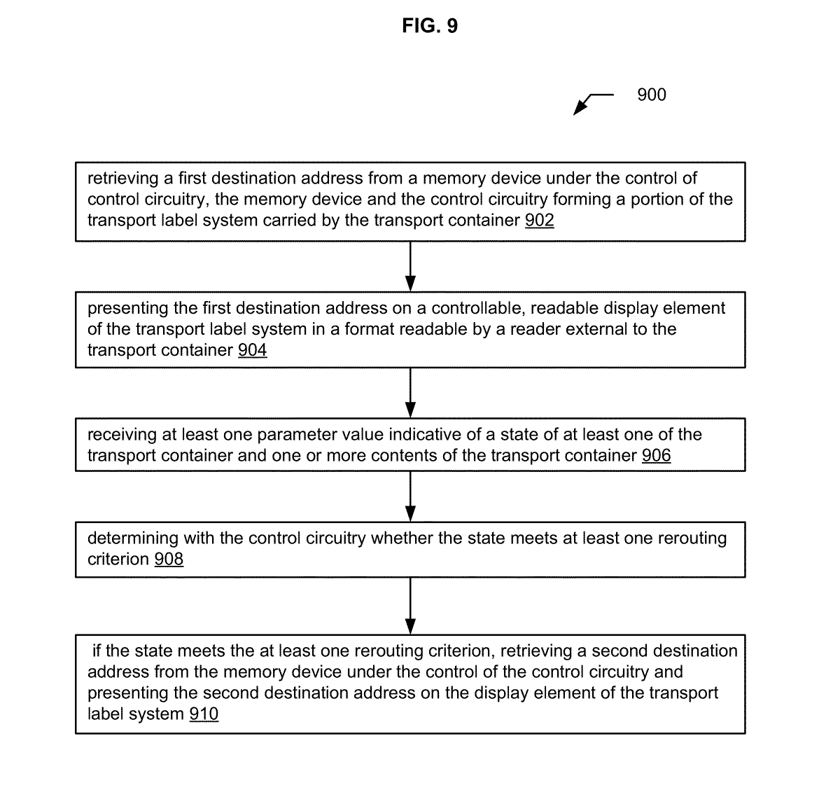

Methods pertaining to the operation of systems as depicted in FIGS. 1A through 8 are described in connection with FIGS. 9 through 16.

FIG. 9 depicts a method 900 of controlling a transport label system carried by a transport container. Method 900 includes retrieving a first destination address from a memory device under the control of control circuitry, the memory device and the control circuitry forming a portion of the transport label system carried by the transport container, as indicated at 902; presenting the first destination address on a controllable, readable display element of the transport label system in a format readable by a reader external to the transport container, as indicated at 904; receiving at least one parameter value indicative of a state of at least one of the transport container and one or more contents of the transport container, as indicated at 906; determining with the control circuitry whether the state meets at least one rerouting criterion, as indicated at 908; and if the state meets the at least one rerouting criterion, retrieving a second destination address from the memory device under the control of the control circuitry and presenting the second destination address on the display element of the transport label system, as indicated at 910.

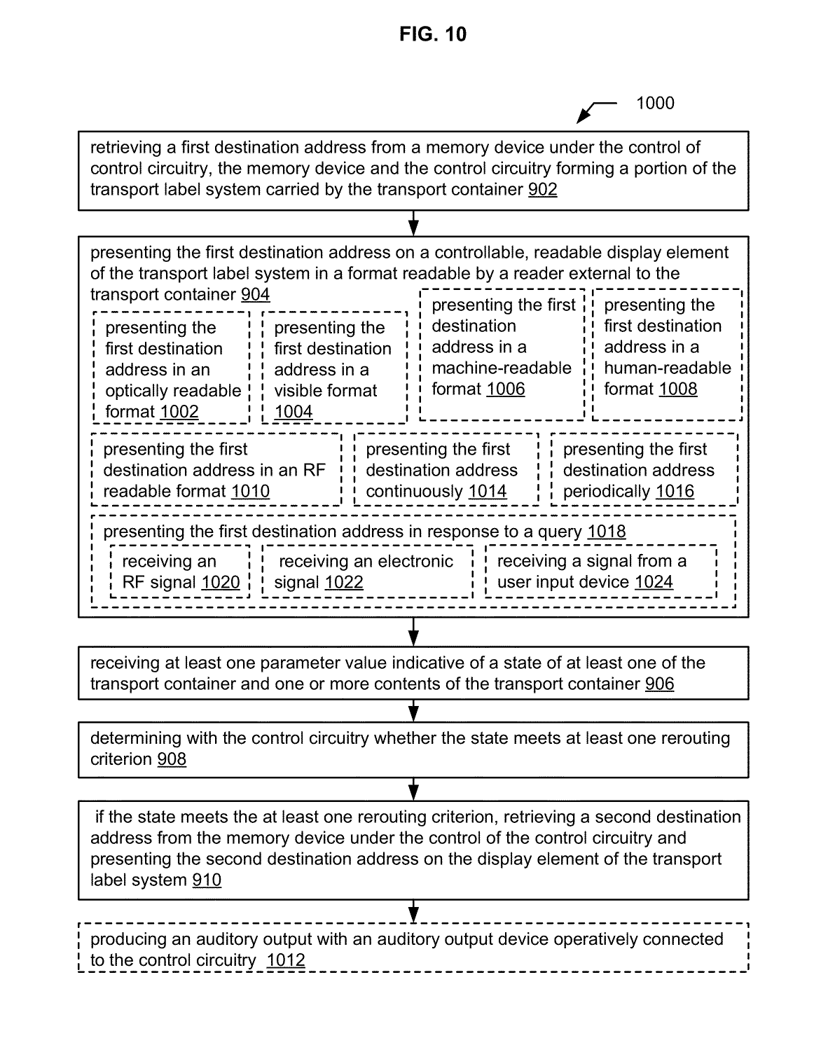

FIGS. 10-16 depict variations and expansions of method 900 as shown in FIG. 9. In the methods depicted in FIGS. 10-16, steps 902-910 are as described generally in connection with FIG. 9. Method steps outlined with dashed lines represent steps that are included in some, but not all method aspects, and combinations of steps other than those specifically depicted in the figures are possible as would be known by those having ordinary skill in the relevant art.

FIG. 10 depicts a method 1000, which is an expansion of method 900 shown in FIG. 9. In various aspects of method 1000, presenting the first destination address on a controllable, readable display element includes presenting the first destination address in an optically readable format, as indicated at 1002, a visible format, as indicated at 1004, a machine-readable format, as indicated at 1006, a human-readable format, as indicated at 1008, an RF readable format, as indicated at 1010.

In an aspect, method 900 includes producing an auditory output with an auditory output device operatively connected to the control circuitry, as indicated at 1012.

In an aspect, presenting the first destination address on a controllable, readable display element includes presenting the first destination address continuously, as indicated at 1014. Alternatively it may include presenting the first destination address periodically, as indicated at 1016. In another aspect, presenting the first destination address on a controllable, readable display element includes presenting the first destination address in response to a query, as indicated at 1018. In connection therewith, the method may include receiving the query, e.g. by receiving an RF signal, as indicated at 1020 or receiving an electronic signal, as indicated at 1022. In an aspect, the method includes receiving a signal from a user input device, as indicated at 1024.

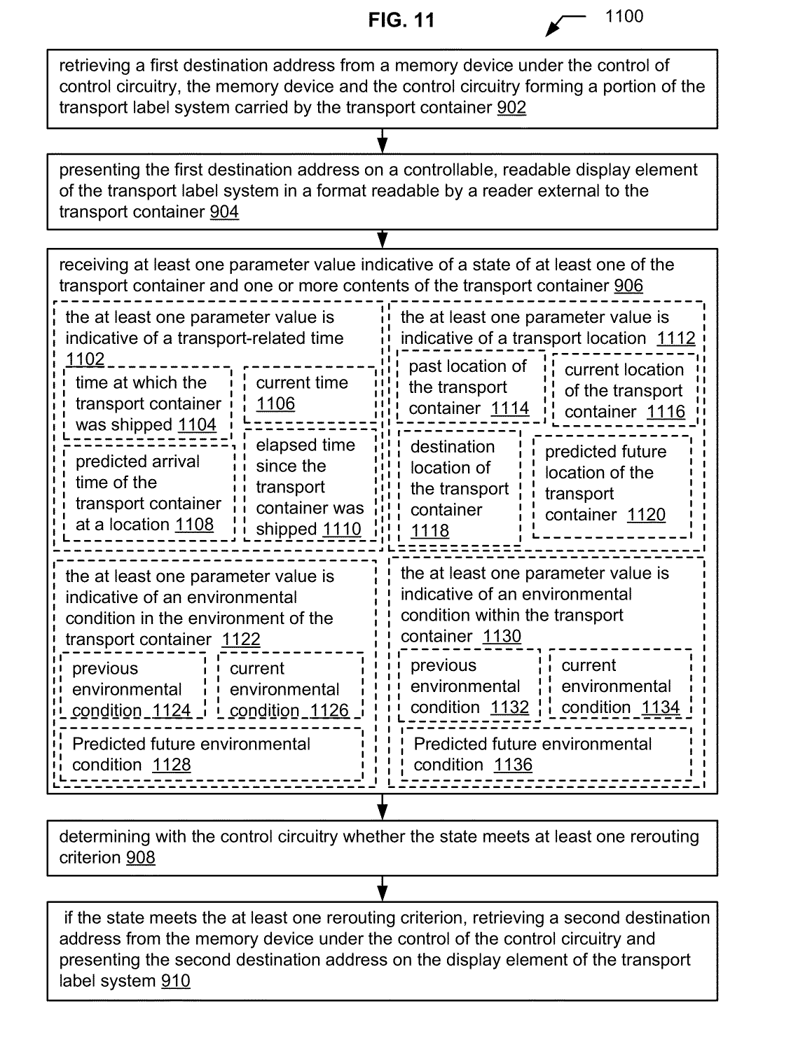

FIG. 11 depicts a method 1100, which is an expansion of method 900 shown in FIG. 9. In an aspect of method 1100, the at least one parameter value is indicative of a transport-related time, as indicated at 1102, which may be, for example, a time at which the transport container was shipped 1104, a current time 1106, a predicted arrival time of the transport container at a location 1108, or an elapsed time since the transport container was shipped 1110. In an aspect, the at least one parameter value is indicative of a transport location, as indicated at 1112, which may be, for example, a past location of the transport container 1114, a current location of the transport container 1116, a destination location of the transport container 1118, or a predicted future location of the transport container 1120.

A past location can be determined based on location information data stored in a memory device located on or associated with the transport label system. Current location can be determined with a location sensing system as described herein above, or any type of location tracking system, local to or remote from the transport label system. A predicted future location or predicted arrival time at a particular location may be determined based on known travel routes and known times for travel between locations along a particular route, which information may be stored in a memory device located on or associated with the transport label system, or received from a database at a remote location.

In an aspect, the at least one parameter value is indicative of an environmental condition in the environment of the transport container, as indicated at 1122. In various aspects, the at least one parameter value is indicative of a previous environmental condition 1124, current environmental condition 1126, or predicted future environmental condition 1128 in the environment of the transport container. Future environmental conditions may be based on extrapolation from current and previously sensed environmental conditions or determined from weather forecast data, for example.

In an aspect, the at least one parameter value is indicative of an environmental condition within the transport container, as indicated at 1130. Again, the environment condition may be a previous environmental condition 1132, current environmental condition 1134, or predicted future environmental condition 1136 within the transport container.

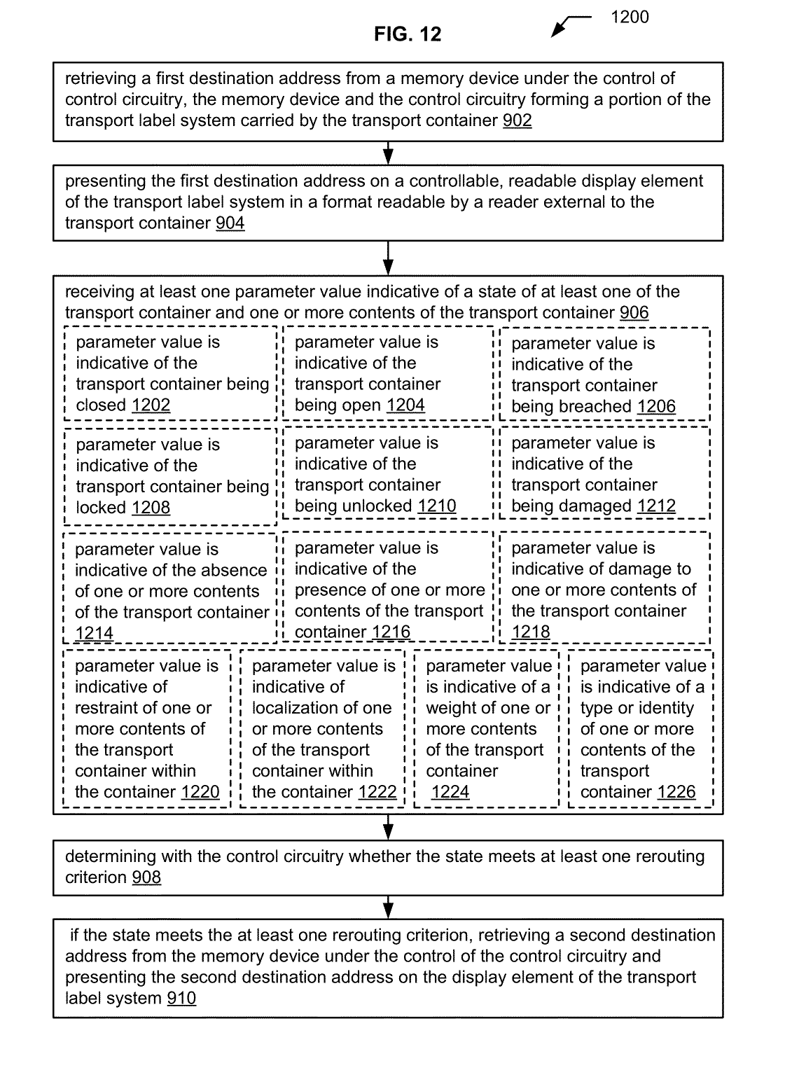

FIG. 12 depicts a method 1200, which is an expansion of method 900 shown in FIG. 9. In various aspects of method 1200, the at least one parameter value is indicative of the transport container being closed, as indicated at 1202; open, as indicated at 1204; or breached, as indicated at 1206; locked, as indicated at 1208; unlocked, as indicated at 1210; or damaged, as indicated at 1212. In various aspects, the at least one parameter value is indicative of the absence, as indicated at 1214, or presence, as indicated at 1216, of one or more contents of the transport container; damage to one or more contents of the transport container, as indicated at 1218; or restraint of one or more contents of the transport container within the container, as indicated at 1220. In various aspect, the at least one parameter value is indicative of localization, as indicated at 1222; weight, as indicated at 1224; type or identity, as indicated at 1226, of one or more contents of the transport container.

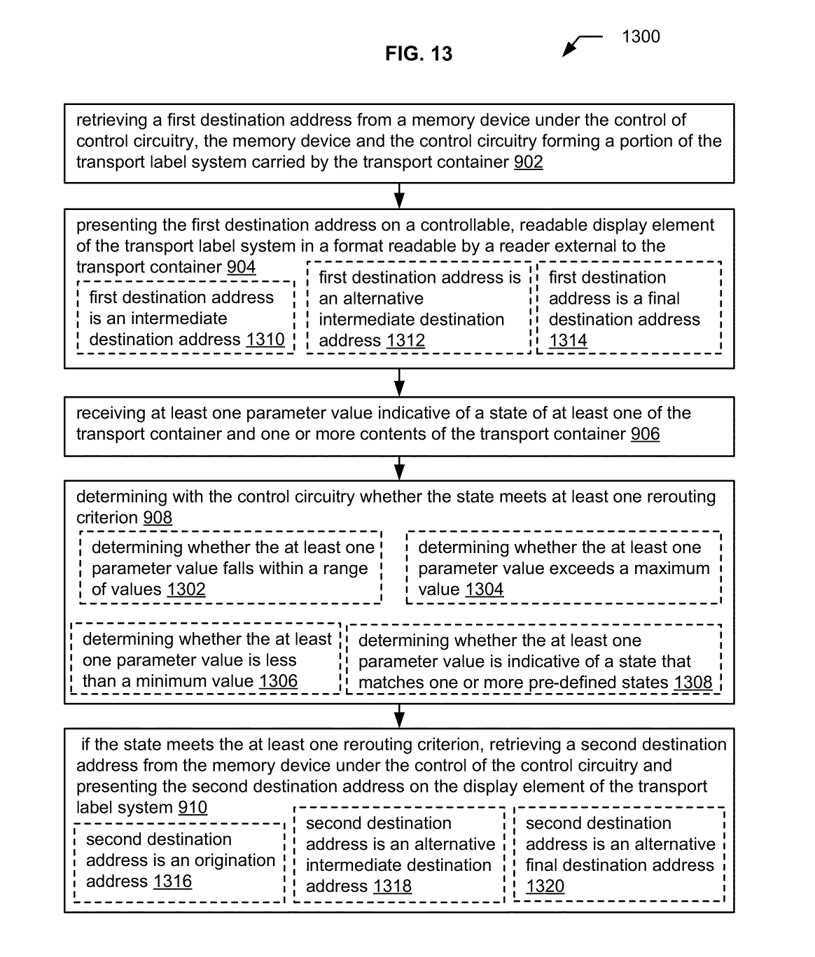

As shown in FIG. 13, in an aspect, method 1300 includes determining that the state meets the at least one rerouting criterion by determining whether the at least one parameter value falls within a range of values, as indicated at 1302, determining whether the at least one parameter value exceeds a maximum value, as indicated at 1304, determining whether the at least one parameter value is less than a minimum value, as indicated at 1306, or determining whether the at least one parameter value is indicative of a state that matches one or more pre-defined states, as indicated at 1308.

In an aspect, the first destination address is an intermediate destination address, as indicated at 1310. In an aspect, the first destination address is a final destination address, as indicated at 1312. In an aspect, the second destination address is an origination address, as indicated at 1314. In an aspect, the second destination address is an alternative final destination address, as indicated at 1316. In an aspect, the first destination address is an alternative intermediate destination address, as indicated at 1318. In an aspect, the second destination address is an alternative intermediate destination address, as indicated at 1320.

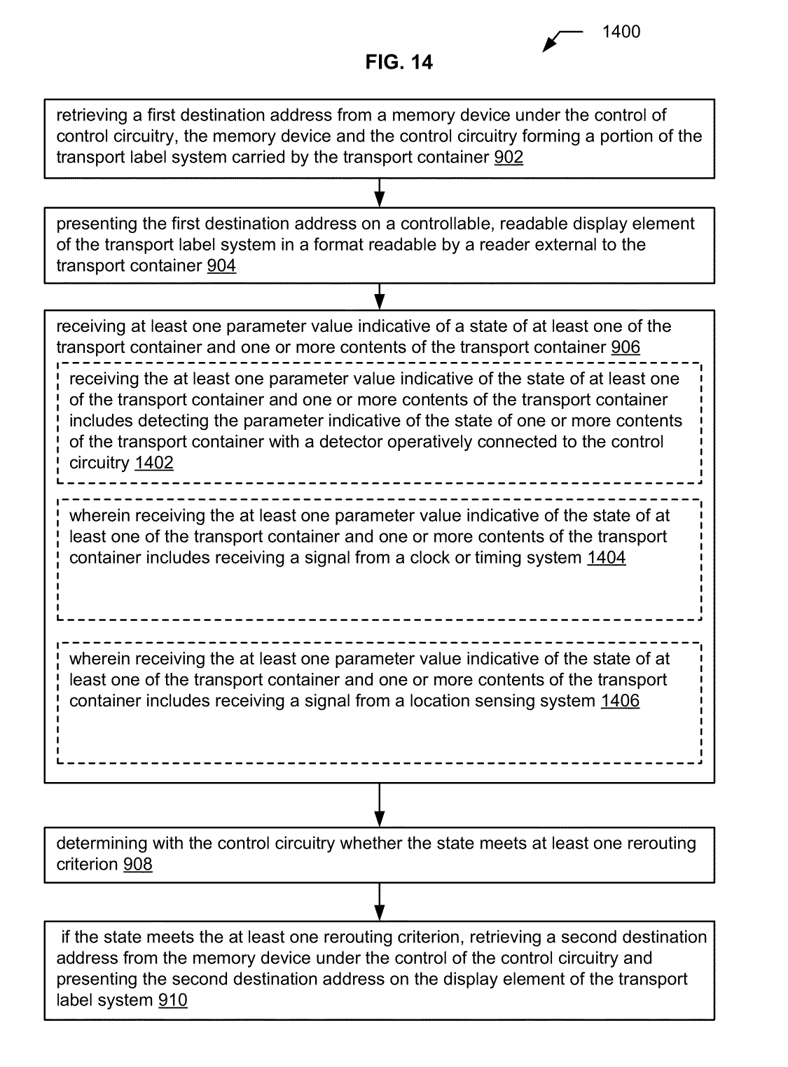

As shown in FIG. 14, in an aspect of method 1400, receiving the at least one parameter value indicative of the state of at least one of the transport container and one or more contents of the transport container includes detecting the parameter indicative of the state of one or more contents of the transport container with a detector operatively connected to the control circuitry, as indicated at 1402. In an aspect, receiving the at least one parameter value indicative of the state of at least one of the transport container and one or more contents of the transport container includes receiving a signal from a clock or timing system, as indicated at 1404. In an aspect, receiving the at least one parameter value indicative of the state of at least one of the transport container and one or more contents of the transport container includes receiving a signal from a location sensing system, as indicated at 1406.

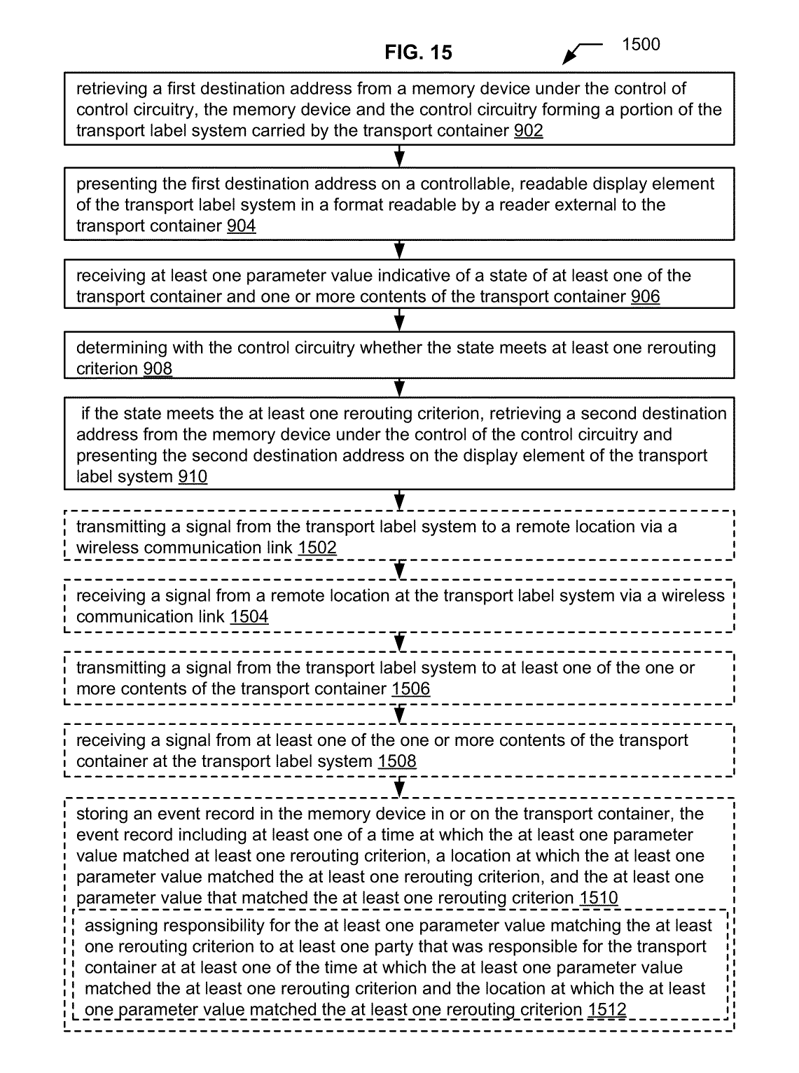

FIG. 15 depicts a method 1500, which is an expansion of method 900 shown in FIG. 9. In an aspect, method 1500 includes transmitting a signal from the transport label system to a remote location via a wireless communication link, as indicated at 1502. In an aspect, method 1500 includes receiving a signal from a remote location at the transport label system via a wireless communication link, as indicated at 1504. In an aspect, method 1500 includes transmitting a signal from the transport label system to at least one of the one or more contents of the transport container, as indicated at 1506. In an aspect, method 1500 includes receiving a signal from at least one of the one or more contents of the transport container at the transport label system, as indicated at 1508. In another aspect, method 1500 includes storing an event record in the memory device in or on the transport container, the event record including at least one of a time at which the at least one parameter value matched at least one rerouting criterion, a location at which the at least one parameter value matched the at least one rerouting criterion, and the at least one parameter value that matched the at least one rerouting criterion, as indicated at 1510. In addition, method 1500 may further include assigning responsibility for the at least one parameter value matching the at least one rerouting criterion to at least one party that was responsible for the transport container at at least one of the time at which the at least one parameter value matched the at least one rerouting criterion and the location at which the at least one parameter value matched the at least one rerouting criterion, as indicated at 1512.

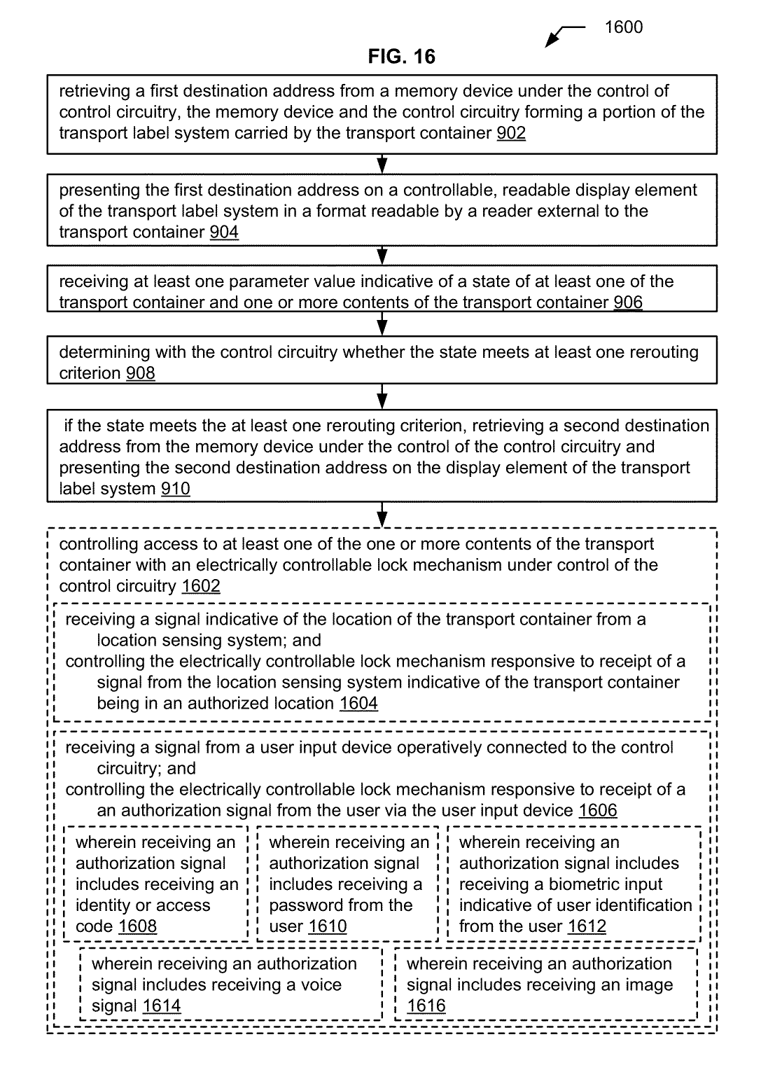

As shown in FIG. 16, in an aspect, a method 1600 includes controlling access to at least one of the one or more contents of the transport container with an electrically controllable lock mechanism under control of the control circuitry, as indicated at 1602.

In an aspect, method 1600 includes receiving a signal indicative of the location of the transport container from a location sensing system, and controlling the electrically controllable lock mechanism responsive to receipt of a signal from the location sensing system indicative of the transport container being in an authorized location, as indicated at 1604. For example, an authorized location may be the home address of the owner of the transport container, the address of a customer to whom the transport container is being shipped, the address of the shipper, etc.

In an aspect, method 1600 includes receiving a signal from a user input device operatively connected to the control circuitry, and controlling the electrically controllable lock mechanism responsive to receipt of a an authorization signal from the user via the user input device, as indicated at 1606. In various aspects, receiving an authorization signal includes receiving an identity or access code, as indicated at 1608, receiving a password from the user, as indicated at 1610, receiving a biometric input indicative of user identification from the user, as indicated at 1612, receiving a voice signal, as indicated at 1614, or receiving an image, as indicated at 1616.

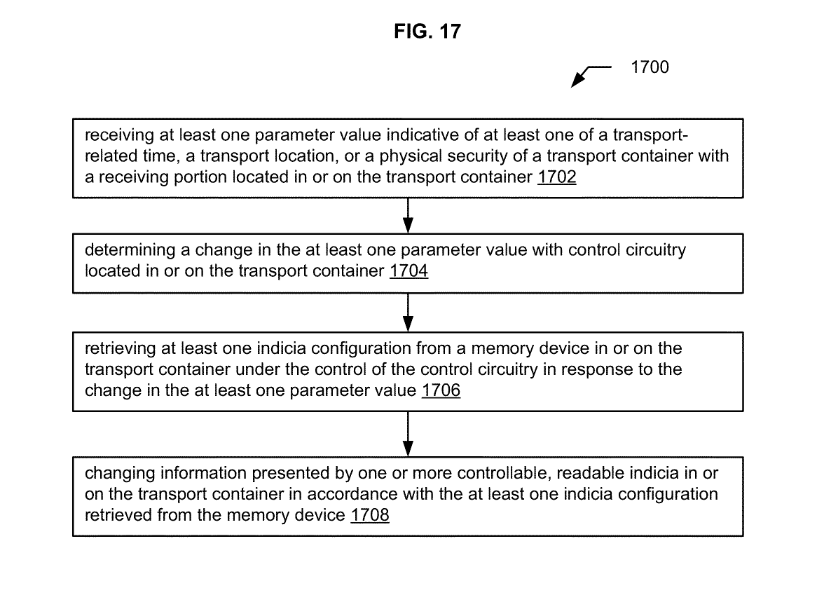

Additional methods pertaining to the operation of systems as depicted in FIGS. 1A through 8 are described in connection with FIGS. 17 through 24.

FIG. 17 is a flow diagram of a method 1700 of controlling one or more controllable, readable indicia on a transport container. Method 1700 includes receiving at least one parameter value indicative of at least one of a transport-related time, a transport location, or a physical security of a transport container with a receiving portion located in or on the transport container, as indicated at 1702; determining a change in the at least one parameter value with control circuitry located in or on the transport container, as indicated at 1704; retrieving at least one indicia configuration from a memory device in or on the transport container under the control of the control circuitry in response to the change in the at least one parameter value, as indicated at 1706; and changing information presented by one or more controllable, readable indicia in or on the transport container in accordance with the at least one indicia configuration retrieved from the memory device, as indicated at 1708.

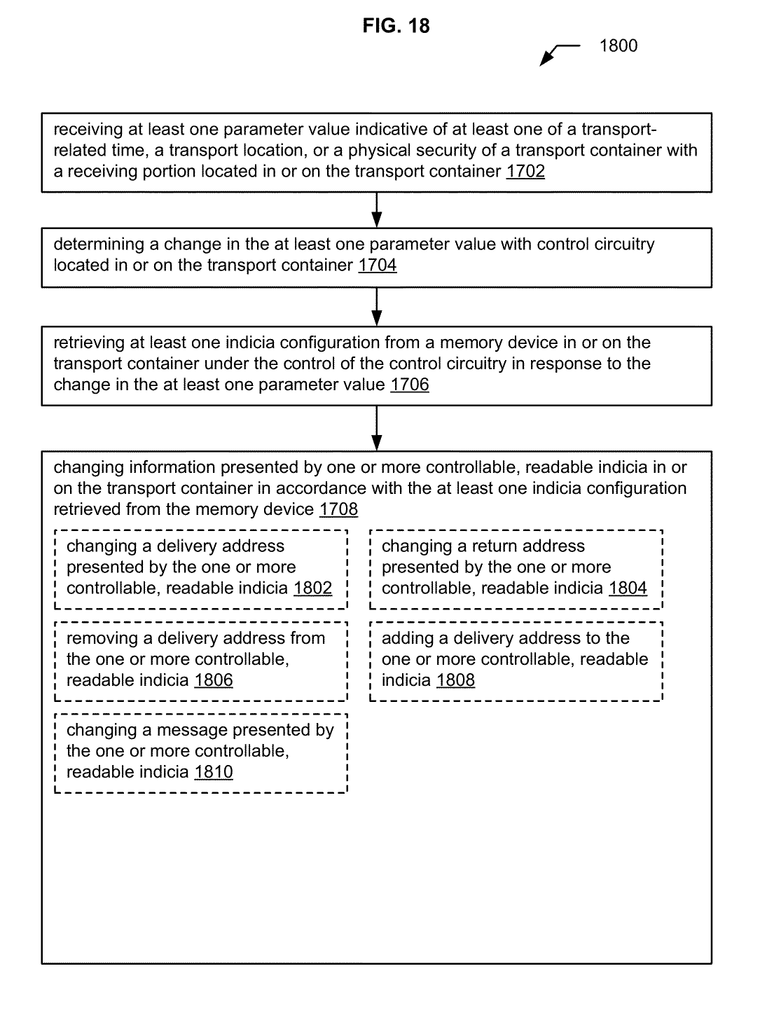

FIGS. 18-24 depict variations and expansions of method 1700 as shown in FIG. 17. In the methods depicted in FIGS. 18-24, steps 1702-1708 are as described generally in connection with FIG. 17. Method steps outlined with dashed lines represent steps that are included in some, but not all method aspects, and combinations of steps other than those specifically depicted in the figures are possible as would be known by those having ordinary skill in the relevant art.

FIG. 18 depicts a method 1800, which is an expansion of method 1700 shown in FIG. 17. In an aspect of method 1800, changing information presented by one or more controllable, readable indicia on the transport container in accordance with the at least one indicia configuration retrieved from the memory device includes changing a delivery address presented by the one or more controllable, readable indicia, as indicated at 1802. In an aspect, changing information presented by one or more controllable, readable indicia on the transport container in accordance with the at least one indicia configuration retrieved from the memory device includes changing a return address presented by the one or more controllable, readable indicia, as indicated at 1804. In an aspect, changing information presented by one or more controllable, readable indicia on the transport container in accordance with the at least one indicia configuration retrieved from the memory device includes removing a delivery address from the one or more controllable, readable indicia, as indicated at 1806. In an aspect, changing information presented by one or more controllable, readable indicia on the transport container in accordance with the at least one indicia configuration retrieved from the memory device includes adding a delivery address to the one or more controllable, readable indicia, as indicated at 1808. In an aspect, changing information presented by one or more controllable, readable indicia on the transport container in accordance with the at least one indicia configuration retrieved from the memory device changing a message presented by the one or more controllable, readable indicia, as indicated at 1810.

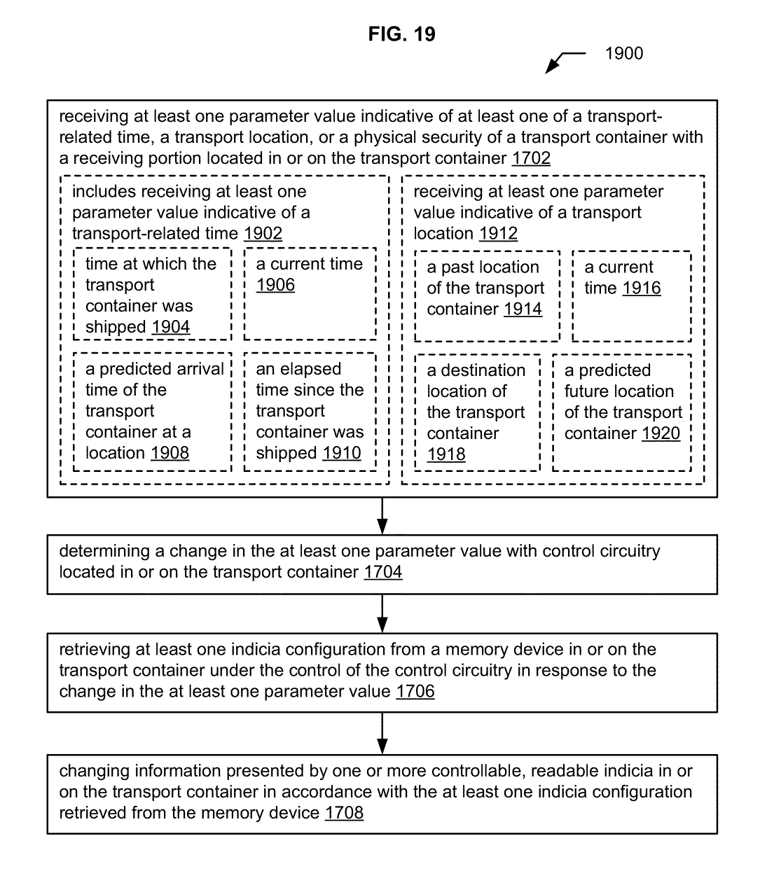

FIG. 19 depicts a method 1900, which is an expansion of method 1700 shown in FIG. 17. In an aspect, receiving at least one parameter value indicative of at least one of a transport-related time, a transport location, or a physical security of a transport container with a receiving portion located in or on the transport container includes receiving at least one parameter value indicative of a transport-related time, as indicated at 1902. In an aspect, the at least one parameter value is indicative of a transport-related time, which may be, for example, a time at which the transport container was shipped, as indicated at 1904, a current time, as indicated at 1906, a predicted arrival time of the transport container at a location, as indicated at 1908, or an elapsed time since the transport container was shipped, as indicated at 1910.

In an aspect, receiving at least one parameter value indicative of at least one of a transport-related time, a transport location, or a physical security of a transport container with a receiving portion located in or on the transport container includes receiving at least one parameter value indicative of a transport location, as indicated at 1912. In an aspect, the at least one parameter value is indicative of a transport location, which may be, for example, a past location of the transport container, as indicated at 1914, a current location of the transport container, as indicated at 1916, a destination location of the transport container, as indicated at 1918, or a predicted future location of the transport container, as indicated at 1920.

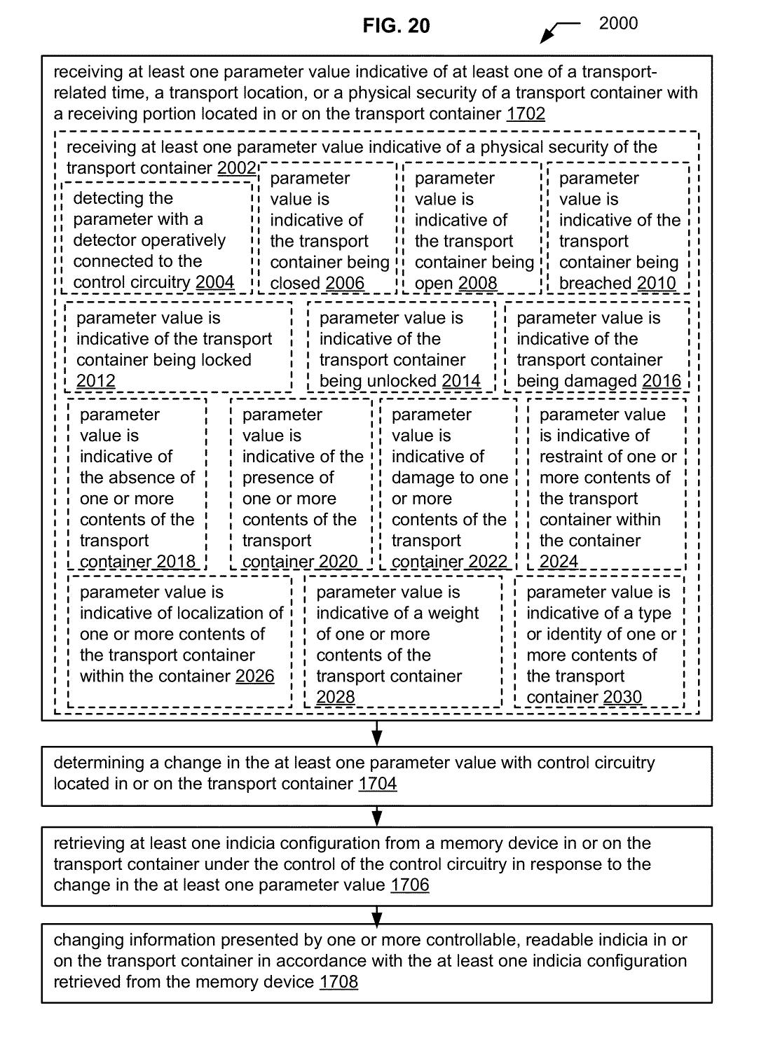

As shown in FIG. 20, in an aspect, a method 2000 includes receiving at least one parameter value indicative of at least one of a transport-related time, a transport location, or a physical security of a transport container with a receiving portion located in or on the transport container includes receiving at least one parameter value indicative of a physical security of the transport container, as indicated at 2002.

In an aspect, receiving at least one parameter value indicative of the physical security of the transport container includes detecting the parameter with a detector operatively connected to the control circuitry, as indicated at 2004.

In various aspects, the at least one parameter value is indicative of the transport container being closed, as indicated at 2006; the transport container being open, as indicated at 2008; breached, as indicated at 2010; the transport container being locked, as indicated at 2012; the transport container being unlocked, as indicated at 2014; the transport container being damaged, as indicated at 2016; the absence of one or more contents of the transport container, as indicated at 2018; the presence of one or more contents of the transport container, as indicated at 2020; damage to one or more contents of the transport container, as indicated at 2022; restraint of one or more contents of the transport container within the container, as indicated at 2024; localization of one or more contents of the transport container within the container, as indicated at 2026; a weight of one or more contents of the transport container, as indicated at 2028; or a type or identity of one or more contents of the transport container, as indicated at 2030.

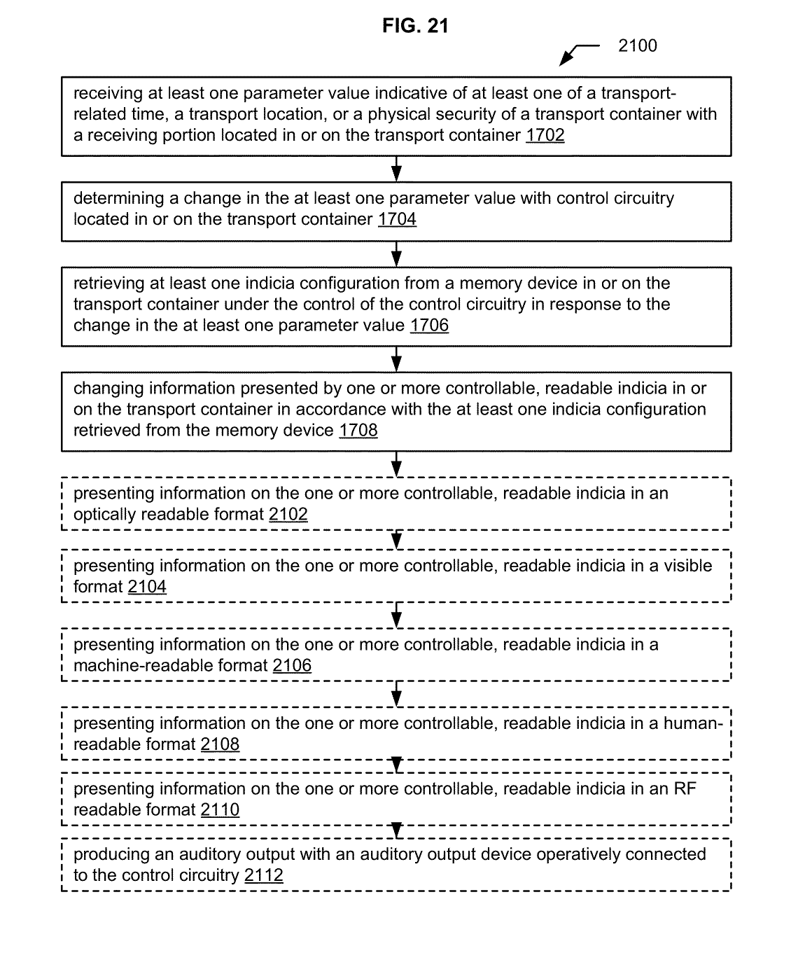

As shown in FIG. 21, in an aspect, a method 2100 includes presenting information on the one or more controllable, readable indicia in an optically readable format, as indicated at 2102, a visible format, as indicated at 2104, a machine-readable format, as indicated at 2106, a human-readable format, as indicated at 2108, or an RF readable format, as indicated at 2110. In an aspect, method 2100 includes producing an auditory output with an auditory output device operatively connected to the control circuitry, as indicated at 2112.

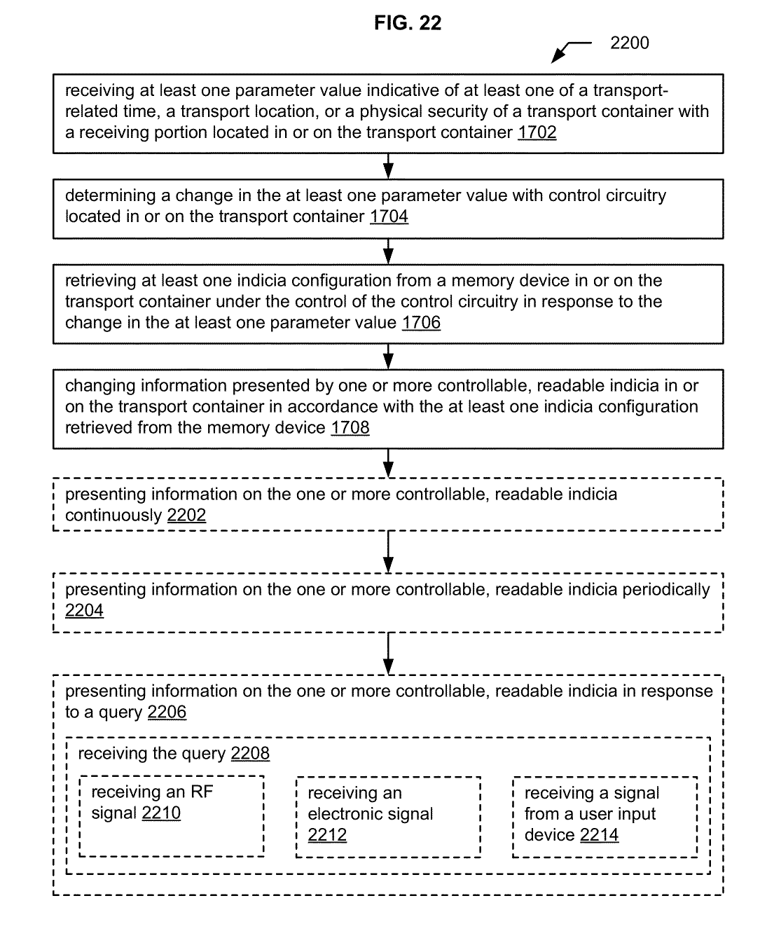

A shown in FIG. 22, in an aspect, method 2200 includes presenting information on the one or more controllable, readable indicia continuously, as indicated at 2202. In another aspect, method 2200 includes presenting information on the one or more controllable, readable indicia periodically, as indicated at 2204. In an aspect, method 2200 includes presenting information on the one or more controllable, readable indicia in response to a query, as indicated at 2206. In an aspect, method 2200 may also include receiving the query, as indicated at 2208, e.g., by at least one of receiving an RF signal 2210, receiving an electronic signal 2212, or receiving a signal from a user input device 2214.

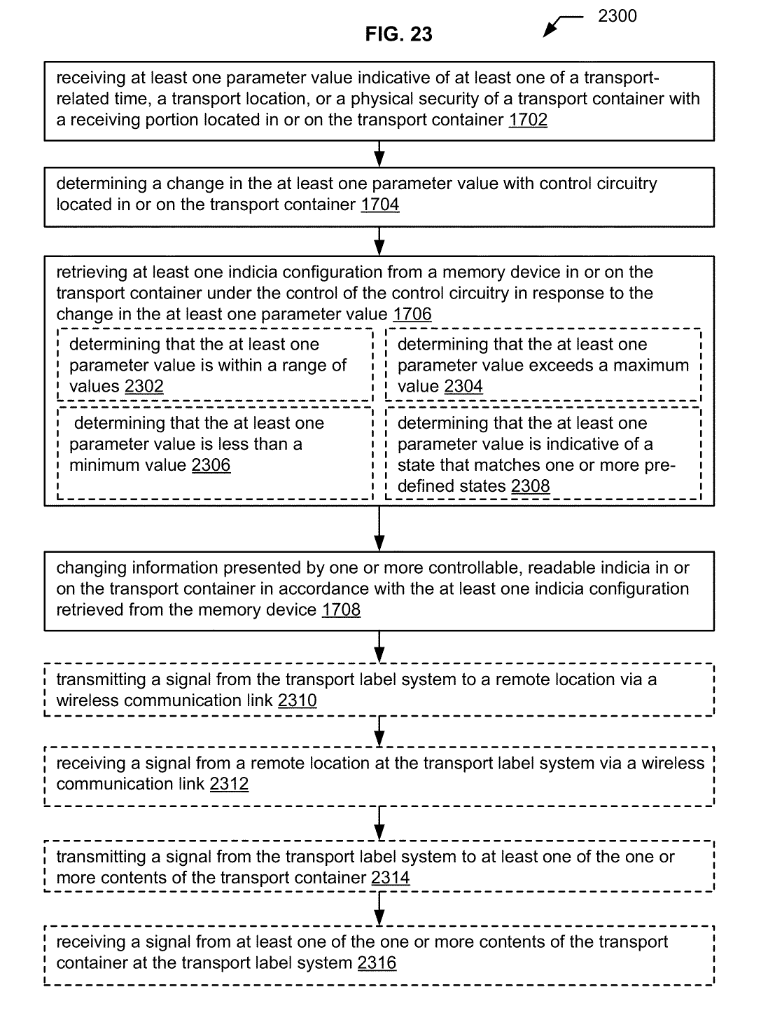

As shown in FIG. 23, in an aspect of method 2300, retrieving at least one indicia configuration from a memory device in or on the transport container under the control of the control circuitry in response to the change in the at least one parameter value includes determining that the at least one parameter value is within a range of values, as indicated at 2302.

In an aspect, retrieving at least one indicia configuration from a memory device in or on the transport container under the control of the control circuitry in response to the change in the at least one parameter value includes determining that the at least one parameter value exceeds a maximum value, as indicated at 2304. In an aspect, retrieving at least one indicia configuration from a memory device in or on the transport container under the control of the control circuitry in response to the change in the at least one parameter value includes determining that the at least one parameter value is less than a minimum value, as indicated at 2306. In an aspect, retrieving at least one indicia configuration from a memory device in or on the transport container under the control of the control circuitry in response to the change in the at least one parameter value includes determining that the at least one parameter value is indicative of a state that matches one or more pre-defined states, as indicated at 2308.

In an aspect, method 2300 includes transmitting a signal from the transport label system to a remote location via a wireless communication link, as indicated at 2310. In an aspect, method 2300 includes receiving a signal from a remote location at the transport label system via a wireless communication link, as indicated at 2312. In an aspect, method 2300 includes transmitting a signal from the transport label system to at least one of the one or more contents of the transport container, as indicated at 2314. In an aspect, method 2300 includes receiving a signal from at least one of the one or more contents of the transport container at the transport label system, as indicated at 2316.

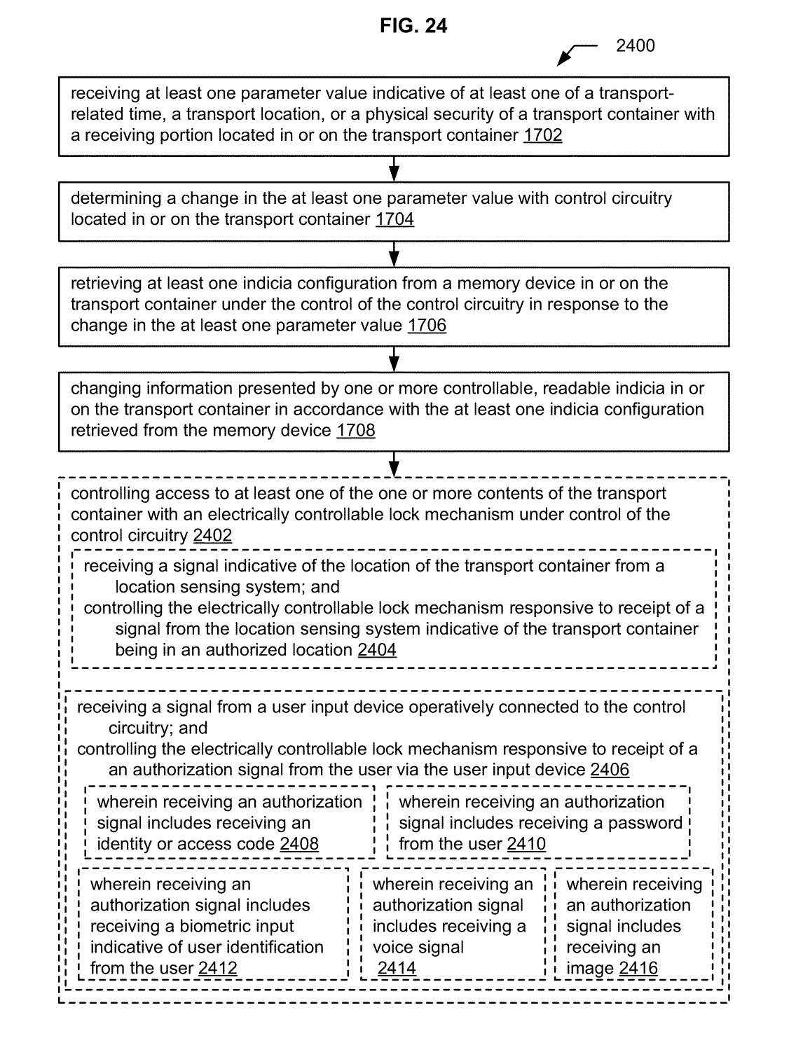

FIG. 24 depicts a method 2400, which is an expansion of method 1700 shown in FIG. 17. In an aspect, method 2400 includes controlling access to at least one of the one or more contents of the transport container with an electrically controllable lock mechanism under control of the control circuitry, as indicated at 2402.

In an aspect, method 2400 includes receiving a signal indicative of the location of the transport container from a location sensing system and controlling the electrically controllable lock mechanism responsive to receipt of a signal from the location sensing system indicative of the transport container being in an authorized location, as indicated at 2404.

In an aspect, method 2400 includes receiving a signal from a user input device operatively connected to the control circuitry and controlling the electrically controllable lock mechanism responsive to receipt of a an authorization signal from the user via the user input device, as indicated at 2406. In various aspects, receiving an authorization signal includes one or more of receiving an identity or access code, as indicated at 2408, receiving a password from the user, as indicated at 2410, receiving a biometric input indicative of user identification from the user, as indicated at 2412, receiving a voice signal, as indicated at 2414, or receiving an image, as indicated at 2416.

In various embodiments, methods as described herein may be performed according to instructions implementable in hardware, software, and/or firmware. Such instructions may be stored in non-transitory machine-readable data storage media, for example. It will be recognized that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

In some implementations described herein, logic and similar implementations may include software or other control structures. Electrical circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components.

Implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). In light of these teachings, it will be possible to obtain, configure, and optimize suitable transmission or computational elements, material supplies, actuators, or other structures. The foregoing detailed description has set forth various embodiments of the devices and/or processes via the use of block diagrams, flowcharts, and/or examples. Insofar as such block diagrams, flowcharts, and/or examples contain one or more functions and/or operations, it should be understood that each function and/or operation within such block diagrams, flowcharts, or examples can be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing media include, but are not limited to non-transitory machine-readable data storage media such as a recordable type medium such as a floppy disk, a hard disk drive, a Compact Disc (CD), a Digital Video Disk (DVD), a digital tape, a computer memory, etc. A signal bearing medium may also include transmission type medium such as a digital and/or an analog communication medium (e.g., a fiber optic cable, a waveguide, a wired communications link, a wireless communication link (e.g., transmitter, receiver, transmission logic, reception logic, etc.) and so forth).

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Such terms (e.g. “configured to”) generally encompass active-state components and/or inactive-state components and/or standby-state components, unless context requires otherwise.

While particular aspects of the present subject matter described herein have been shown and described, it will be apparent that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of controlling one or more controllable, readable indicia on a transport container, comprising:
receiving at least one parameter value indicative of at least one of a transport-related time, a transport location, or a physical security of a transport container with a receiving portion located in or on the transport container;
determining a change in the at least one parameter value with control circuitry located in or on the transport container;
retrieving at least one indicia configuration from a memory device in or on the transport container under the control of the control circuitry in response to the change in the at least one parameter value; and
changing information presented by one or more controllable, readable indicia in or on the transport container in accordance with the at least one indicia configuration retrieved from the memory device.

2.-6. (canceled)

7. The method of claim 1, wherein receiving at least one parameter value indicative of at least one of a transport-related time, a transport location, or a physical security of a transport container with a receiving portion located in or on the transport container includes receiving at least one parameter value indicative of a transport-related time.

8.-11. (canceled)

12. The method of claim 1, wherein receiving at least one parameter value indicative of at least one of a transport-related time, a transport location, or a physical security of a transport container with a receiving portion located in or on the transport container includes receiving at least one parameter value indicative of a transport location.

13.-16. (canceled)

17. The method of claim 1, wherein receiving at least one parameter value indicative of at least one of a transport-related time, a transport location, or a physical security of a transport container with a receiving portion located in or on the transport container includes receiving at least one parameter value indicative of a physical security of the transport container.

18.-29. (canceled)

30. The method of claim 17, wherein receiving at least one parameter value indicative of the physical security of the transport container includes detecting the parameter with a detector operatively connected to the control circuitry.

31.-52. (canceled)

53. The method of claim 1, comprising storing an event record in the memory device in or on the transport container, the event record including at least one of a time at which the at least one parameter value matched at least one rerouting criterion, a location at which the at least one parameter value matched the at least one rerouting criterion, and the at least one parameter value that matched the at least one rerouting criterion.

54. The method of claim 53, comprising assigning responsibility for the at least one parameter value matching the at least one rerouting criterion to at least one party that was responsible for the transport container at at least one of the time at which the at least one parameter value matched the at least one rerouting criterion and the location at which the at least one parameter value matched the at least one rerouting criterion.

55.-61. (canceled)

62. A transport label system, comprising:
one or more controllable, readable indicia configured to be carried in or on a transport container, the one or more controllable, readable indicia adapted to present information in a format readable by a reader external to the transport container;
at least one receiving portion configured to be carried in or on the transport container, the at least one receiving portion adapted to receive at least one parameter value indicative of at least one of a transport-related time, a transport location, or a physical security of the transport container;
a memory device configured to be carried in or on the transport container, the memory device configured to store at least a first indicia configuration and a second indicia configuration, wherein at least one of the first indicia configuration and the second indicia configuration includes information to be presented by the one or more controllable, readable indicia; and
control circuitry configured to:
determine a change in the at least one parameter value;
select one indicia configuration from the at least a first indicia configuration and the at least a second indicia configuration based upon the change in the at least one parameter value; and
configure the one or more controllable, readable indicia according to the selected one indicia configuration.

63. The transport label system of claim 62, wherein the one or more controllable, readable indicia are configured as a transport label adapted for attachment to the transport container.

64.-65. (canceled)

66. The transport label system of claim 62, wherein the memory device, the one or more controllable, readable indicia, the receiving portion and the control circuitry are built into the transport container.

67.-68. (canceled)

69. The transport label system of claim 62, further comprising at least one detector configured to detect a parameter indicative of a state of the at least one of the transport container and one or more contents of the transport container, the at least one detector operatively connected to the receiving portion and adapted to provide the at least one parameter value indicative of the state of the at least one of the transport container and one or more contents of the transport container to the receiving portion.

70.-108. (canceled)

109. The transport label system of claim 62, comprising a clock or timing system operatively connected to the receiving portion, wherein the receiving portion is adapted to receive the at least one parameter value from the clock or timing system.

110. A transport container system, comprising:
a transport container;
one or more controllable, readable indicia in or on the transport container adapted to present information in a format readable by a reader external to the transport container;
at least one receiving portion adapted to receive at least one parameter value indicative of at least one of a transport-related time, a transport location, or a physical security of the transport container;
a memory device in or on the transport and configured to store at least a first indicia configuration and a second indicia configuration, wherein at least one of the first indicia configuration and the second indicia configuration includes information to be presented by the one or more controllable, readable indicia; and
control circuitry configured to:
determine a change in the at least one parameter value;
select one indicia configuration of the at least a first indicia configuration and the at least a second indicia configuration based upon the change in the at least one parameter value; and
configure the one or more controllable, readable indicia according to the selected one indicia configuration.

111.-116. (canceled)

117. The transport container system of claim 110, further comprising a location sensing system in communication with the control circuitry, wherein the control circuitry is configured to control the one or more controllable, readable indicia based at least in part upon receipt of a signal from the location sensing system.

118. The transport container system of claim 110, wherein the transport container includes:
a shell adapted to receive one or more contents to be contained in the transport container; and
at least one cover adapted to allow access to the one or more contents when in an open configuration and to enclose and contain the one or more contents when in a closed configuration;
wherein at least one of the memory device, receiving portion, and control circuitry are located within the shell.

119. (canceled)

120. The transport container system of claim 118, further comprising at least one electrically controllable lock mechanism configured to lock the cover in the closed configuration.

121.-135. (canceled)

136. The transport container system of claim 110, wherein the control circuitry is configured for wired communication with one or more contents of the transport container.

137. The transport container system of claim 110, further comprising at least one detector configured to detect the at least one parameter value indicative of the physical security of the transport container, the at least one detector operatively connected to the receiving portion and adapted to provide the at least one parameter value to the receiving portion.

138.-158. (canceled)

159. The method of claim 1, wherein changing information presented by one or more controllable, readable indicia on the transport container in accordance with the at least one indicia configuration retrieved from the memory device includes changing at least one of a delivery address presented by the one or more controllable, readable indicia; changing a return address presented by the one or more controllable, readable indicia; removing a delivery address from the one or more controllable, readable indicia; adding a delivery address to the one or more controllable, readable indicia; and changing a message presented by the one or more controllable, readable indicia.

160. The method of claim 7, wherein the transport-related time is at least one of a time at which the transport container was shipped, a current time, a predicted arrival time of the transport container at a location, and an elapsed time since the transport container was shipped.

161. The method of claim 12, wherein the transport location is at least one of a past location of the transport container, a current location of the transport container, a destination location of the transport container, and a predicted future location of the transport container.

162. The method of claim 17, wherein the at least one parameter value is indicative of at least one of the transport container being closed, the transport container being open, the transport container being locked, the transport container being unlocked, the transport container being damaged, absence of one or more contents of the transport container, presence of one or more contents of the transport container, damage to one or more contents of the transport container, restraint of one or more contents of the transport container within the container, localization of one or more contents of the transport container within the container, weight of one or more contents of the transport container, type of one or more contents of the transport container, and identity of one or more contents of the transport container.

163. The method of claim 1, comprising presenting information on the one or more controllable, readable indicia in at least one of an optically readable format, a visible format, a machine-readable format, a human-readable format, and an RF readable format.

164. The method of claim 1, comprising at least one of presenting information on the one or more controllable, readable indicia continuously; presenting information on the one or more controllable, readable indicia periodically; and presenting information on the one or more controllable, readable indicia in response to a query.

165. The method of claim 1, comprising:
receiving a query; and
presenting information on the one or more controllable, readable indicia in response to a query;
wherein receiving the query includes at least one of receiving an RF signal, receiving an electronic signal, receiving a signal from a user input device.

166. The method of claim 1, wherein retrieving at least one indicia configuration from the memory device in or on the transport container under the control of the control circuitry in response to the change in the at least one parameter value includes at least one of determining that the at least one parameter value is within a range of values, determining that the at least one parameter value exceeds a maximum value, determining that the at least one parameter value is less than a minimum value, and determining that the at least one parameter value is indicative of a state that matches one or more pre-defined states.

167. The method of claim 1, comprising at least one of transmitting a signal from the transport label system to a remote location via a wireless communication link, receiving a signal from a remote location at the transport label system via a wireless communication link, transmitting a signal from the transport label system to at least one of the one or more contents of the transport container, receiving a signal from at least one of the one or more contents of the transport container at the transport label system, and receiving a signal from at least one of the one or more contents of the transport container at the transport label system.

168. The method of claim 53, comprising at least one of:
receiving a signal indicative of the location of the transport container from a location sensing system and controlling the electrically controllable lock mechanism responsive to receipt of a signal from the location sensing system indicative of the transport container being in an authorized location; and
receiving a signal from a user input device operatively connected to the control circuitry and controlling the electrically controllable lock mechanism responsive to receipt of an authorization signal from the user via the user input device.

169. The method of claim 53, comprising:
receiving an authorization signal from a user input device operatively connected to the control circuitry; and
controlling the electrically controllable lock mechanism responsive to receipt of an authorization signal from the user via the user input device;
wherein receiving the authorization signal includes receiving at least one of an identity code, an access code, a password, a biometric input indicative of user identification, a voice signal, and an image.

170. The transport label system of claim 62, comprising at least one of communication circuitry operatively connected to the control circuitry and adapted for wireless communication with a remote location and communication circuitry operatively connected to the control circuitry and adapted for communication with one or more contents of the transport container.

171. The transport label system of claim 69, wherein the at least one detector includes at least one of a detector configured to detect whether the transport container is closed, a detector configured to detect whether the transport container is locked, a detector configured to detect the presence or absence of one or more contents in the transport container, a detector configured to detect the type of one or more contents in the transport container, a detector configured to detect the identity of one or more contents in the transport container, a detector configured to detect a weight of the contents of the transport container, an electrical sensor, an optical sensor, a pressure sensor, a force sensor, a temperature sensor, an accelerometer, an electromagnetic sensor, a magnetic sensor, and an acoustic sensor.

172. The transport label system of claim 62, wherein the one or more controllable, readable indicia includes at least one of electronic ink, an RFID, a tactile display, a visual display, optically detectable indicia, electromagnetically detectable indicia, and magnetically detectable indicia.

173. The transport label system of claim 62, further comprising an auditory output device adapted to produce an auditory output indicative of the destination address selected from at least the first destination address and the second destination address.

174. The transport label system of claim 62, comprising at least one of an RF receiver operatively connected to the control circuitry, wherein the RF receiver is adapted for receiving a query, and a user input device operatively connected to the control circuitry, wherein the user input device is adapted for receiving a query from a user.

175. The transport label system of claim 62, wherein the control circuitry is configured to select the one indicia configuration based upon the change in the at least one parameter value by at least one of determining whether the at least one parameter value falls within a range of values, determining whether the at least one parameter value exceeds a maximum value, determining whether the at least one parameter value is less than a minimum value, and determining whether the at least one parameter value is indicative of a state that matches one or more pre-defined states.

176. The transport label system of claim 62, comprising at least one of a location sensing system operatively connected to the receiving portion, wherein the receiving portion is adapted to receive the at least one parameter value from the location sensing system; and a clock or timing system operatively connected to the receiving portion, wherein the receiving portion is adapted to receive the at least one parameter value from the clock or timing system.

177. The transport container system of claim 110, wherein the transport container is selected from the list consisting of a shipping container, a cargo container, a box, a crate, a suitcase, and an instrument case.

178. The transport container system of claim 120, further comprising at least one of a location sensing system in communication with the control circuitry, wherein the control circuitry is configured to control the at least one electrically controllable lock mechanism responsive to receipt of a signal from the location sensing system indicative of the transport container system being in an authorized location; and a user input device mounted on an exterior portion of the shell, wherein the control circuitry is configured to control the at least one electrically controllable lock mechanism responsive to receipt of an authorization signal from a user via the user input device.

179. The transport container system of claim 120, further comprising a user input device, wherein the control circuitry is configured to control the at least one electrically controllable lock mechanism responsive to receipt of an authorization signal from a user via the user input device, and wherein the user input device includes at least one of a keyboard, a keypad, a touch sensitive device, a touch operated device, a voice interface, a digital data reader, a bar code reader, a magnetic strip reader, a data tag reader, an RFID reader, a near field communication device, and a device adapted to receive an identity code, access code, password, biometric input indicative of user identification, voice signal, or image.

180. The transport container system of claim 110, comprising at least one of communication circuitry operatively connected to the control circuitry and adapted for wireless communication with one or more contents of the transport container, communication circuitry operatively connected to the control circuitry and adapted for wired communication with one or more contents of the transport container, and communication circuitry operatively connected to the control circuitry and adapted for wireless communication with a remote location.

181. The transport container system of claim 137, wherein the at least one detector includes at least one of a detector configured to detect whether the transport container is closed, a detector configured to detect whether the transport container is locked, a detector configured to detect presence or absence of one or more contents of the transport container, a detector configured to detect type or identity of one or more contents of the transport container, a detector configured to detect the weight of one or more contents of the transport container, an electrical sensor, an optical sensor, a pressure sensor, a force sensor, and an acoustic sensor.

182. The transport container system of claim 110, wherein the controllable, readable indicia include at least one of indicia adapted to present a destination address selected from at least a first destination address and a second destination address in a format readable by a human, indicia adapted to present a destination address selected from at least a first destination address and a second destination address in a format readable by a machine, electronic ink, an RFID, a tactile display, a visual display, optically detectable indicia, electromagnetically detectable indicia, and magnetically detectable indicia.

183. The transport container system of claim 110, further comprising an auditory output device adapted to produce an auditory output indicative of a destination address selected from at least a first destination address and a second destination address.
